(19) United States
(12) Patent Application Publication
(10) Pub. No.: US 2009/0240700 A1
(43) Pub. Date: Sep. 24, 2009

(54) DISTRIBUTED FILE MANAGEMENT SYSTEM

(76) Inventor: Akihito Hayashi, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/281,017

(22) PCT Filed: Mar. 7, 2007
(86) PCT No.: PCT/JP2007/054421

§ 371 Date: Aug. 28, 2008

(30) Foreign Application Priority Data
Mar. 8, 2006 (JP) 2006-062640

(51) Int. Cl. G06F 17/30; G06F 12/00

(52) U.S. Cl. 707/10; 707/201; 707/E17.01; 707/E17.032; 707/E17.005; 707/8

(57) ABSTRACT

To provide a distributed file management apparatus or method which can reduce communication traffic on a network and wasteful use of storage resources of servers as much as possible.

One of a plurality of servers in a distributed file management system receives a request of a user sent from a terminal regarding an electronic file, executes processing related to the request of the user, and sends a result of the executed processing to the terminal, each server being connected via a communication line to the terminal used by the user and each server including a file storage unit storing an electronic file. The distributed file management system includes a distributed file management apparatus which sends, in response to an inquiry from an access source server receiving the request of the user regarding the electronic file, information concerning a holding server including the file storage unit that stores the electronic file related to the request of the user, to the access source server.

### TECHNICAL FIELD

The present invention relates to a system which manages electronic files distributed on a computer network (referred to as a “network” hereafter).

### BACKGROUND ART

By making use of a network, a user can access, from a terminal used by the user, electronic files stored in another terminal or a server, via the network. Thus, each user of the terminals can use the electronic files distributed on the network. This accordingly promotes distribution of information and supports the user to easily obtain new information.

Conventionally, technologies related to efficient use and management of electronic files distributed on a network have been suggested.

For example, a technology disclosed in Patent Reference 1 is regarding a file system management method of presenting the user a tree-structured virtual file system which has a super directory as a root for integrating file systems of servers. With this technology, the user can access electronic files stored in another server using the same interface that is used for accessing electronic files stored in a user's own terminal.

Moreover, a technology disclosed in Patent Reference 2 is regarding a mechanism or method whereby, not that one electronic file held by one server is shared with terminals connected on a network, but all the servers hold the same electronic file or the same electronic file group and contents of the electronic file or the electronic file group are completely synchronized among the servers.

### Patent Reference 1: Japanese Unexamined Patent Application Publication No. 5-250249

### Patent Reference 2: Japanese Unexamined Patent Application Publication No. 10-510413

### DISCLOSURE OF INVENTION

### Problems that Invention is to Solve

The conventional technologies, however, increase the amount of information moving on the network or cause a problem that storage resources of the servers are wastefully used.

For example, using the technology disclosed in Patent Reference 1, when an electronic file is updated, the update processing needs to be performed only for the server which holds this electronic file. This can be said to be efficient.

However, when an electronic file stored in another server is obtained, information of this electronic file needs to be sent via the network every time the electronic file is accessed, thereby increasing the amount of information moving on the network. This problem is serious when the user frequently accesses to obtain this electronic file.

On the other hand, using the technology disclosed in Patent Reference 2, for example, when an electronic file is to be obtained, communications take place only between a terminal and a server on the network.

However, note here that the same file is stored in more than one server. For this reason, when the contents of the electronic file are updated, new contents of the electronic file need to be sent to every server. This increases the amount of information moving on the network. Moreover, even an electronic file which is less frequently used is stored in all the servers, and this thus leads to wasteful use of the storage resources.

The present invention has been conceived in view of the stated problem, and has an object of providing a distributed file management apparatus or method which can reduce communication traffic on a network and wasteful use of storage resources of servers as much as possible.

### Means to Solve the Problems

In order to achieve the stated object, a distributed file management system of the present invention is a system in which one of a plurality of servers, each being connected via a communication line to a terminal used by a user and each including a file storage unit storing an electronic file, receives a request of the user sent from the terminal regarding an electronic file, executes processing related to the request of the user, and sends a result of the executed processing to the terminal, the distributed file management system including a distributed file management apparatus which sends, in response to an inquiry from an access source server receiving the request of the user regarding the electronic file, information concerning a holding server including the file storage unit that stores the electronic file related to the request of the user, to the access source server.

Preferably, the distributed file management apparatus includes: a file location storing unit which stores file location information in which server identification information for each server is associated with information concerning the electronic file stored in the file storage unit included in the server; a holding server determining unit which determines the holding server by reference to the file location information, in response to the inquiry from the access source server; and a holding server sending unit which sends, to the access source server, the information concerning the holding server determined by the holding server determining unit.

Also, the distributed file management system further includes a plurality of servers, wherein each of the plurality of servers includes: a request receiving unit which receives the request inputted to the terminal by the user; a holding server receiving unit which receives the information concerning the holding server that is sent from the holding server sending unit; an access destination determining unit which determines an access destination related to the request of the user, on the basis of the information concerning the holding server that is received by the holding server receiving unit; a processing requesting unit which requests the access destination, which is determined by the access destination determining unit, to perform the processing related to the request of the user; a result obtaining unit which obtains, from the access destination, a result of the processing which the processing requesting unit requests the access destination to perform; and a result sending unit which sends the result obtained by the result obtaining unit to the terminal.

Moreover, each server further includes a completion judging unit which judges that the processing related to the request of the user is completed when the result obtaining unit obtains the result of the processing related to the request of the user from each access destination determined by the access destination determining unit, and the result sending unit sends the result of the processing related to the request of the user to the terminal when the completion judging unit judges that the processing related to the request of the user is completed.

Furthermore, each server further includes a completion notifying unit which, when the completion judging unit judges that the processing related to the request of the user is completed, notifies the distributed file management apparatus of: information concerning the access destination where write processing is performed in relation to the request of the user; and information concerning the electronic file, and the distributed file management apparatus further includes a location information updating unit which updates the file location information with the information concerning the access destination and the information concerning the electronic file obtained from the completion notifying unit.

In this way, the distributed file management apparatus stores the location of the electronic file. For this reason, the server can determine which server has the electronic file related to the request of the user, by inquiring of the distributed file management apparatus.

Accordingly, the user can obtain a desired electronic file without thinking about which server has which electronic file. When the user requests to update an electronic file stored in a different server, the contents of the electronic file can be synchronized among the servers.

More preferably, the distributed file management apparatus further includes a lock instruction sending unit which, when the holding server determining unit judges that the request of the user is to write an electronic file and that the holding server is present, sends the holding server an instruction to lock the file storage unit included in the holding server.

Also, the distributed file management apparatus further includes a lock release sending unit which, when receiving the notification from the completion notifying unit, sends the holding server, to which the lock instruction sending unit sent the instruction, an instruction to unlock the file storage unit included in the holding server.

In this way, when the request from the user is to write an electronic file, the file storage unit included in the server to which the electronic file is to be written is locked. On account of this, the accuracy in synchronizing the contents of the electronic file which is stored in different servers can be further improved.

More preferably, the access destination determining unit includes a first determining unit which, when: the request of the user is to obtain an electronic file; the file storage unit included in the access source server does not store the electronic file related to the request of the user; and the information concerning the holding server that is received by the holding server receiving unit includes the server identification information, determines that the server specified by the information concerning the holding server is the access destination relevant to processing of obtaining the electronic file related to the request of the user and determines that the file storage unit included in the access source server is the access destination relevant to processing of writing the electronic file related to the request of the user.

Moreover, each server further includes a writing unit which writes the electronic file to the electronic file storage unit and, after completion of the write processing, notifies the result obtaining unit that the write processing is completed, the processing requesting unit requests, when the first determining unit determines the access destination, the server specified by the information concerning the holding server to send the electronic file related to the request of the user, and requests the writing unit included in the access source server to write the electronic file related to the request of the user, the result obtaining unit obtains, as a result of the processing related to the request of the user, the electronic file related to the request of the user from the server specified by the information concerning the holding server, and obtains the notification, from the writing unit included in the access source server, that the processing of writing the electronic file is completed, the completion judging unit judges, when the result obtaining unit obtains the electronic file related to the request of the user and the notification of the completion of the write processing, that the processing related to the request of the user is completed, and the result sending unit sends, when the completion judging unit judges that the processing related to the request of the user is completed, the terminal the electronic file related to the request of the user that is obtained by the result obtaining unit.

Furthermore, the completion notifying unit notifies, when the completion judging unit judges that the processing related to the request of the user is completed, the distributed file management apparatus of the information concerning the access source server and the information concerning the electronic file obtained by the result obtaining unit, and the location information updating unit updates the file location information by storing, into the file location storage unit, the information concerning the access source server and the information concerning the electronic file obtained from the completion notifying unit, the pieces of information being stored in association with each other.

In this way, when an electronic file the user wishes to obtain is not stored in the server accessed by the user, the server accessed by the user obtains this electronic file from a different server and then stores the obtained electronic file in its own file storage unit. Thus, the electronic files stored in the servers in common are limited to the electronic files that have been accessed before by the user. Accordingly, the wasteful use of the storage resources of the servers can be reduced as much as possible.

As described above, the electronic file that is once obtained by the user is held by the server that the user accesses at the time. On account of this, when the user tries to obtain the same electronic file once again from the same server, the present server can provide the user with the electronic file stored in this server itself. Accordingly, the amount of information moving on the network can be reduced and the electronic file having been obtained before can be speedily provided to the user.

More preferably, the access destination determining unit includes a second determining unit which, when: the request of the user is to write an electronic file; and the information concerning the holding server that is received by the holding server receiving unit includes the server identification information, determines that the file storage unit included in the access source server and the server specified by the information concerning the holding server are the access destinations relevant to processing of writing the electronic file related to the request of the user.

Also, each server further includes a writing unit which writes the electronic file to the electronic file storage unit and, after completion of the write processing, notifies the result obtaining unit that the write processing is completed, the processing requesting unit requests, when the second determining unit determines the access destination, the server specified by the information concerning the holding server and the writing unit included in the access source server to write the electronic file related to the request of the user, the result obtaining unit obtains, as a result of the processing related to the request of the user, the notification of the completion of the write processing from the server specified by the information concerning the holding server and the writing unit included in the access source server, the completion judging unit judges, when the result obtaining unit obtains the notification of the completion of the write processing from the holding server and the writing unit included in the access source server, that the processing related to the request of the user is completed, and the result sending unit sends, when the completion judging unit judges that the processing related to the request of the user is completed, the notification of the completion of the write processing to the terminal.

Moreover, the completion notifying unit notifies, when the completion judging unit judges that the processing related to the request of the user is completed, the distributed file management apparatus of the information concerning the electronic file related to the request of the user, the information concerning the access source server, and the information concerning the holding server, and the location information updating unit updates the file location information by storing, into the file location storage unit, the information concerning the electronic file related to the request of the user, the information concerning the access source server, and the information concerning the holding server obtained from the completion notifying unit, the pieces of information being stored in association with each other.

In this way, when the request from the user is to write an electronic file, the server receiving the request from the user determines, by inquiring of the distributed file management apparatus, that a server having the present electronic file is the access destination. Moreover, the server receiving the request from the user determines that its own file storage unit is also the access destination.

Then, the electronic file is written to the file storage unit which is the access destination and to the file storage unit included in the server which is the access destination.

Thus, between the servers having the same electronic file, the contents of this electronic file can be synchronized. Moreover, when requesting to write an electronic file, the user does not need to think about such synchronization. This accordingly improves convenience for the user. Moreover, when the server serving as the access destination receives a request from the user to obtain this electronic file, the server serving as the access destination can speedily provide this electronic file to the user.

More preferably, the access destination determining unit includes a third determining unit which, when: the request of the user is to write an electronic file; and the information concerning the holding server that is received by the holding server receiving unit does not include the server identification information, determines that the file storage unit included in the access source server is the access destination relevant to processing of writing the electronic file related to the request of the user.

Moreover, each server further includes a writing unit which writes the electronic file to the electronic file storage unit and, after completion of the write processing, notifies the result obtaining unit that the write processing is completed, the processing requesting unit requests, when the third determining unit determines the access destination, the writing unit included in the access server to write the electronic file related to the request of the user, the result obtaining unit obtains, as a result of the processing related to the request of the user, the notification of the completion of the write processing from the writing unit included in the access source server, the completion judging unit judges, when the result obtaining unit obtains the notification of the completion of the write processing from the writing unit included in the access source server, that the processing related to the request of the user is completed, and the result sending unit sends, when the completion judging unit judges that the processing related to the request of the user is completed, the notification of the completion of the write processing to the terminal.

Furthermore, the completion notifying unit notifies, when the completion judging unit judges that the processing related to the request of the user is completed, the distributed file management apparatus of the information concerning the electronic file related to the write request of the user and the information concerning the access source server, and the location information updating unit updates the file location information by storing, into the file location storage unit, the information concerning the electronic file related to the request of the user and the information concerning the access source server obtained from the completion notifying unit, the pieces of information being stored in association with each other.

In this way, when receiving a request from the user to write an electronic file which is not stored in any server, the server receiving the request from the user writes the electronic file to its own file storage unit. Then, the server receiving the request from the user notifies the distributed file management apparatus that the new electronic file is stored in the server itself.

Thus, when the user sends the present server a request to obtain the electronic file, this server can speedily provide the electronic file to the user. Moreover, when a difference server receives the request from the user to obtain the electronic file, this server can provide the electronic file to the user by inquiring of the distributed file management apparatus.

It should be noted that the present invention can be realized not only as the distributed file management system including the distributed file management apparatus and the servers having such characteristic units, but also as: a distributed file management method having the characteristic units included in the distributed file management system as its steps; and a program causing a computer to function as the characteristic units included in the distributed file management system. Such a program can be distributed via a recording medium such as a CD-ROM (Compact Disc-Read Only Memory), or via a communication network such as the Internet.

### EFFECTS OF THE INVENTION

Using the present invention, the user can obtain a desired electronic file without thinking about which server has which electronic file.

Also, when the user requests to update an electronic file stored in a different server, the contents of this electronic file can be synchronized among the servers.

Moreover, the electronic files stored in the servers in common are limited to the electronic files that have been accessed before by the user. Accordingly, the wasteful use of the storage resources of the servers can be reduced as much as possible.

Furthermore, when the user tries to obtain the same electronic file once again from the same server, the present server can provide the user with the electronic file stored in this server itself. Accordingly, the amount of information moving on the network can be reduced and the electronic file having been obtained before can be speedily provided to the user.

### BRIEF DESCRIPTION OF DRAWINGS

FIG. 1 is a diagram showing a configuration outline of a distributed file management system according to an embodiment.

FIG. 2 is a diagram showing an example of an electronic file path which is common to electronic file information stored in a file storage unit of each server, according to the present embodiment.

FIG. 3 is a diagram showing an example of electronic file information stored in a file storage unit included in a server A, according the present embodiment.

FIG. 4 is a diagram showing an example of electronic file information stored in a file storage unit included in a server B, according the present embodiment.

FIG. 5 is a diagram showing an example of electronic file information stored in a file storage unit included in a server C, according the present embodiment.

FIG. 6 is a block diagram showing functional configurations of a distributed file management apparatus and each server, according to the present embodiment.

FIG. 7 is a diagram showing an example of management server information stored in a holding server storage unit.

FIG. 8 is a diagram showing an example of holding server information stored in the holding server storage unit.

FIG. 9 is a time chart showing examples of processing executed by apparatuses included in the distributed file management system according to the present embodiment and of information sent and received among the apparatuses, when the user sends a file obtainment request from a terminal.

FIG. 10 is a time chart showing examples of processing executed by apparatuses included in the distributed file management system according to the present embodiment and of information sent and received among the apparatuses, when the user sends a file write request from the terminal.

FIG. 11 is a time chart of a case where the user using a terminal a sends a server A a request to obtain a file a.

FIG. 12 is a time chart of a case where the user using the terminal a sends the server A a request to obtain a file e.

FIG. 13 is a diagram showing the electronic file information stored in the file storage unit of the server A after the execution of the processing performed when the user using the terminal a sends the server A the request to obtain the file e.

FIG. 14 is a diagram showing the holding server information stored in the holding server storage unit after the execution of the processing performed when the user using the terminal a sends the server A the request to obtain the file e.

FIG. 15 is a time chart of a case where the user using the terminal a sends the server A a request to obtain a file g.

FIG. 16 is a time chart of a case where the user using the terminal a sends the server A a request to write the file g.

FIG. 17 is a diagram showing the electronic file information stored in the file storage unit included in the server A after the execution of the processing performed when the user using the terminal a sends the server A the request to write the file g.

FIG. 18 is a diagram showing the holding server information stored in the holding server storage unit after the execution of the processing performed when the user using the terminal a sends the server A the request to write the file g.

FIG. 19 is a time chart of a case where the user using the terminal a sends the server A a request to update a file b.

FIG. 20 is a diagram showing the electronic file information stored in the file storage unit included in the server A after the execution of the processing performed when the user using the terminal a sends the server A the request to update the file b.

FIG. 21 is a diagram showing the holding server information stored in the holding server storage unit after the execution of the processing performed when the user using the terminal a sends the server A the request to update the file b.

FIG. 22 is a time chart of a case where the user using the terminal a sends the server A a request to update the file a.

FIG. 23 is a diagram showing the electronic file information stored in the file storage unit included in the server A after the execution of the processing performed when the user using the terminal a sends the server A the request to update the file a.

FIG. 24 is a diagram showing the electronic file information stored in the file storage unit included in the server B after the execution of the processing performed when the user using the terminal a sends the server A the request to update the file a.

FIG. 25 is a diagram showing the holding server information stored in the holding server storage unit after the execution of the processing performed when the user using the terminal a sends the server A the request to update the file a.

FIG. 26 is a time chart of a case where the user using the terminal a sends the server A a request to write a file d.

FIG. 27 is a diagram showing the electronic file information stored in the file storage unit included in the server A after the execution of the processing performed when the user using the terminal a sends the server A the request to write the file d.

FIG. 28 is a diagram showing the holding server information stored in the file storage unit included in the server B after the execution of the processing performed when the user using the terminal a sends the server A the request to write the file d.

FIG. 29 is a diagram showing the electronic file information stored in the file storage unit included in the server C after the execution of the processing performed when the user using the terminal a sends the server A the request to write the file d.

FIG. 30 is a diagram showing the holding server information stored in the holding server storage unit after the execution of the processing performed when the user using the terminal a sends the server A the request to write the file d.

FIG. 31 is a diagram showing an example of a screen which is displayed on a monitor connected to the terminal used by the user and which is used by the user for inputting a request regarding a specific file.

FIG. 32 is a diagram showing an example of a result displayed on the monitor connected to the terminal used by the user, when the user specifies a request to obtain the file a.

FIG. 33 is a diagram showing an example of a result displayed on the monitor connected to the terminal used by the user, when the user specifies a request to update the file a.

### NUMERICAL REFERENCES

10 distributed file management apparatus
15, 50 communication lines
20, 30, 40 servers
25, 35, 45 file storage units
60, 65 terminals
71 request receiving unit
73 access destination determining unit
75 write file holding unit
77 file storage control unit
79 access destination inquiring unit
81 access destination receiving unit
83 processing requesting unit
85 result obtaining unit
87 completion judging unit
89 completion notifying unit
91 result sending unit
100 holding server storage unit
102 inquiry receiving unit
104 holding server determining unit
106 access destination responding unit
108 notification receiving unit
110 holding information updating unit
112 control instruction sending unit

### BEST MODE FOR CARRYING OUT THE INVENTION

The following is a description of an embodiment of a distributed file management apparatus according to the present invention, with reference to the drawings.

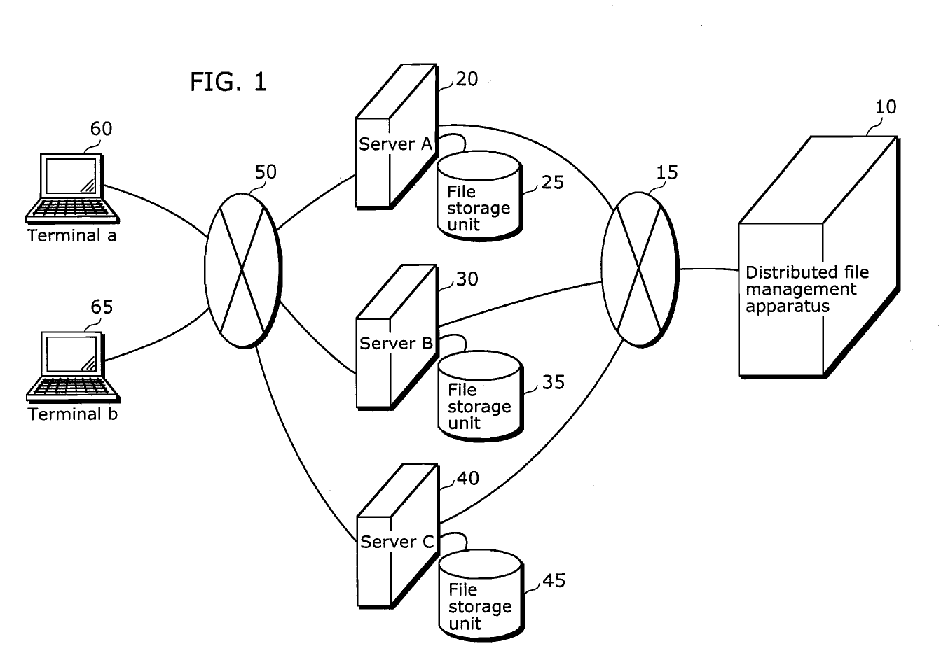

FIG. 1 is a diagram showing a configuration outline of a distributed file management system according to the present embodiment. Using a terminal, a user sends a server a request regarding an electronic file and obtains a result of the processing performed by the server and the distributed file management apparatus in response to the request of the user.

The distributed file management system according to the present embodiment is an example of a system whereby one of a plurality of servers, which are connected via a communication line to the terminal used by the user and which each have a file storage unit for storing an electronic file, receives a request of the user sent from the terminal regarding the electronic file, executes processing related to the request of the user, and sends a result of the executed processing to the terminal used by the user.

The distributed file management system according to the present embodiment includes a distributed file management apparatus 10, a server A20, a server B30, a server C40, a terminal a60, and a terminal b65.

The distributed file management apparatus according to the present embodiment is an example of an apparatus which manages information concerning electronic files stored and held by the servers 20, 30, and 40 and which sends, in response to an inquiry from an access source server that receives a request regarding an electronic file from the user, information related to holding servers to the access source server.

Here, the holding servers refers to the servers respectively including file storage units 25, 35, and 45 which store the electronic file related to the request of the user.

The distributed file management apparatus 10 treats the server A20, the server B30, and the server C30 as its management objects, and manages information concerning the electronic files stored and held by the server A20, information concerning electronic files stored and held by the server B30, and information concerning electronic files stored and held by the server C.

A communication line 15 is a LAN (Local Area Network) or a WAN (Wide Area Network) for example, and connects the distributed file management apparatus and each of the servers 20, 30, and 40.

The server A20 is an apparatus which receives a request regarding an electronic file from the terminals 60 and 65 used by the users and from the other servers 30 and 40. When receiving a request, the server A20 processes the received request in conjunction with the distributed file management apparatus 10 as necessary and sends a result of the processing to the sender of the request.

The server A20 includes the file storage unit 25 which stores electronic files.

The server B30 and the server C40 also have the same function, and respectively include the file storage unit 35 and the file storage unit 45.

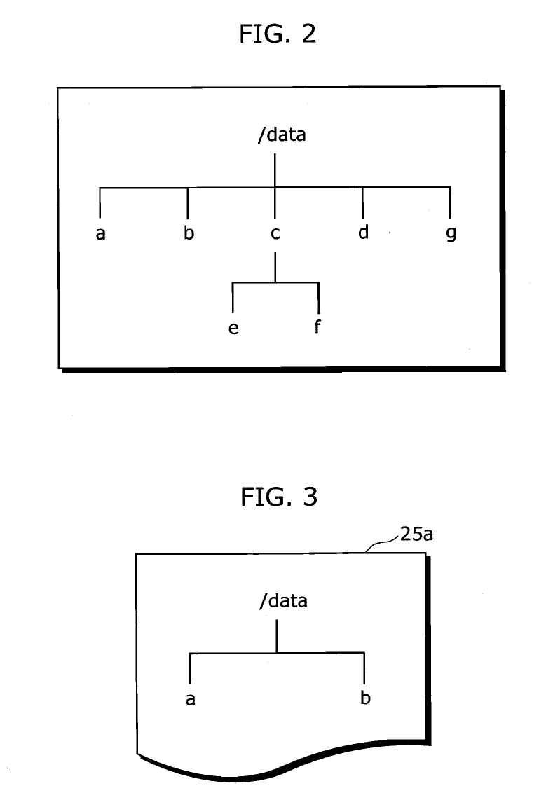

Here, an explanation is given as to an example of a file structure of the electronic files stored in the file storage units 25, 35, and 45 according to the present embodiment, with reference to FIG. 2. Also, specific examples of the electronic files stored in the file storage units 25, 35, and 45 are explained, with reference to FIGS. 3 to 5.

FIG. 2 is a diagram showing an example of a folder structure which is common to the electronic files stored in each of the file storage units included in the servers according to the present embodiment. When an electronic file managed by the distributed file management apparatus 10 is held by a server, the server holds the file in accordance with a predetermined common folder structure.

Using the terminal 60 or 65, the user specifies the electronic file according to a path presenting the predetermined common folder structure as shown in the present diagram, and then sends a request regarding the specified electronic file to one of the servers 20, 30, and 40, such as a server previously set by the terminals 60 and 65.

Here, as the “request regarding the specified electronic file”, there are: an obtainment request which is a request to obtain an electronic file; and a write request to write an electronic file. The write request includes a request to update an existing electronic file and a request to store a new electronic file.

Each electronic file shown in the present diagram is specified by a relative path whose root is a folder related to a folder name “/data”.

Immediately under the folder whose folder name is “/data”, there are an electronic file whose file name is “a”, an electronic file whose file name is “b”, an electronic file whose file name is “d”, an electronic file whose file name is “g”, and a folder whose folder name is “c”.

Immediately under the folder whose folder name is “c”, there are an electronic file whose file name is “e” and an electronic file whose file name is “f”.

Here, an “electronic file” includes information which is an entity of the electronic file, as well as including attribute information of the file, such as a file name and an update date and time of the file. This is the same in the description given hereafter.

Moreover, in the following description, a simple “file x” refers to an electronic file whose file name is “x”. Similarly, a simple “folder x” refers to a folder whose folder name is “x”.

FIG. 3 is a diagram showing an example of electronic file information 25a stored in the file storage unit 25 included in the server A20 according to the present embodiment. This diagram shows an example where the file storage unit 25 of the present embodiment stores the “file a” and the “file b”.

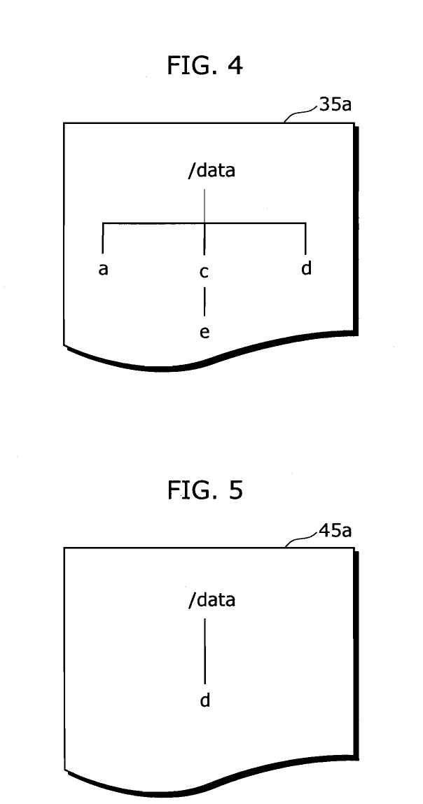

FIG. 4 is a diagram showing an example of electronic file information 35a stored in the file storage unit 35 included in the server B30 according to the present embodiment. This diagram shows an example where the file storage unit 35 of the present embodiment stores the “file a”, the “file d”, and the “file e”.

FIG. 5 is a diagram showing an example of electronic file information 45a stored in the file storage unit 45 included in the server C40 according to the present embodiment. This diagram shows an example where the file storage unit 45 of the present embodiment stores the “file d”.

Here, the explanation returns to FIG. 1.

A communication line 50 is a LAN or a WAN, for example, and connects the servers 20, 30, and 40 to the terminals 60 and 65.

The terminal a60 is used by the user. When receiving a request regarding an electronic file from the user, the terminal a60 sends the request to one of the servers 20, 30, and 40. Then, when obtaining a result from the server to which the request was sent, the terminal a60 presents the obtained result to the user by displaying the obtained result on a monitor, for example. The terminal b65 also has the same function.

As described so far, each file shown in the predetermined file structure is held by a plurality of servers in a distributed manner. Even when the user accesses the server which does not hold the electronic file desired by the user, the distributed file management apparatus 10 allows the processing requested by the user regarding the electronic file.

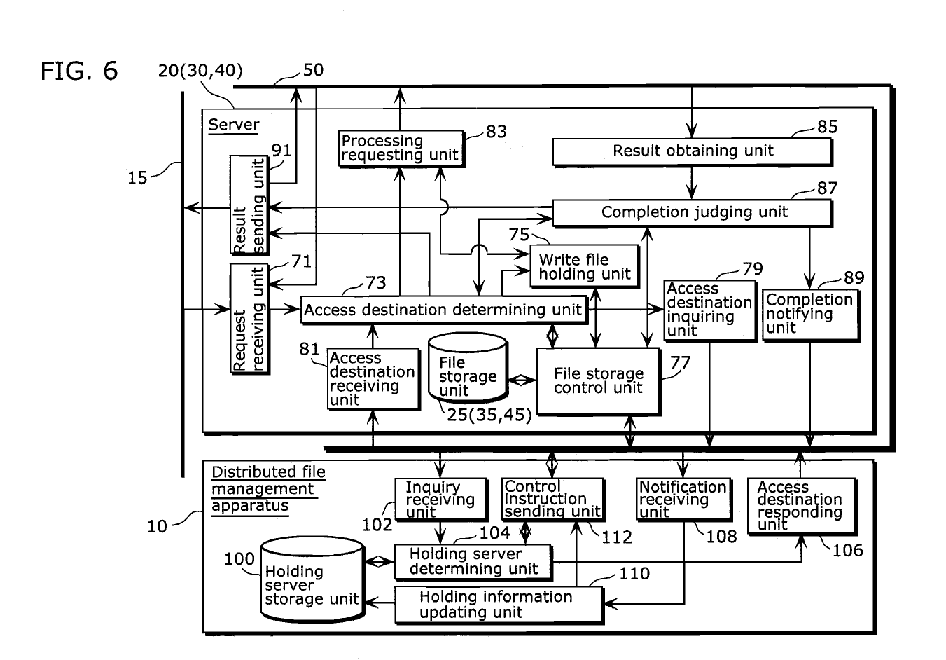

An explanation is given as to a functional configuration included in each apparatus in order to allow such processing, with reference to FIG. 6.

FIG. 6 is a block diagram showing functional configurations of the distributed file management apparatus 10 and the server 20 (or, 30 or 40), according to the present embodiment.

First, the server A20 includes the file storage unit 25, a request receiving unit 71, an access destination determining unit 73, a write file holding unit 75, a file storage control unit 77, an access destination inquiring unit 79, an access destination receiving unit 81, a processing requesting unit 83, a result obtaining unit 85, a completion judging unit 87, a completion notifying unit 89, and a result sending unit 91.

The file storage unit 25 has been explained with reference to FIG. 3 and therefore the explanation is omitted here.

The request receiving unit 71 receives a request, via the communication line 50, from the terminal 60 or 65 used by the user, and also receives requests from the other servers 30 and 40 via the communication line 15. To be more specific, the request receiving unit 71 is an example of a request receiving unit which receives a request inputted to the terminal by the user.

The access destination determining unit 73 determines an access destination to meet the request received by the request receiving unit 71. The access destination determining unit 73 is an example of an access destination determining unit which determines an access destination related to the request from the user, on the basis of information concerning a holding server received by the access destination receiving unit 81 described later as an example of a holding server receiving unit.

In the present embodiment, as the request received by the request receiving unit 71, there are an obtainment request and a write request as described above.

The access destination determining unit 73 of the present embodiment determines an access destination based on a sender of the request received by the request receiving unit 71 and on details of the request. Moreover, in case of necessity, the access destination determining unit 73 determines an access destination based on one of or both: a result of searching the electronic file information 25a (or, 35a or 45a) stored in its own file storage unit 25 (or, 35 or 45); and a result obtained by inquiring of the distributed file management apparatus 10.

Here, “its own file storage unit” refers to the file storage unit 25 (or, 35 or 45) included in the server 20 (or, 30 or 40) that includes the present access destination determining unit 73. Similarly, when the term “its own” is added to a unit name in the following description, this means that this unit is included in the server that includes the current subject of the action.

To be more specific, when the sender of the request is the other server, the access destination determining unit 73 determines that its own file storage unit 25 (or, 35 or 45) is the access destination.

When the sender of the request is the terminal 60 (or 65) and the request is an obtainment request, the access destination determining unit 73 further obtains a result of searching whether or not the electronic file information 25a (or, 35a or 45a) stored in its own file storage unit 25 (or, 35 or 45) includes the electronic file related to the obtainment request and then determines the access destination on the basis of the obtained search result.

Here, when obtaining the result that the electronic file information 25a (or, 35a or 45a) includes the electronic file related to the obtainment request, the access destination determining unit 73 determines that its own file storage unit 25 (or, 35 or 45) is the access destination.

Or, when obtaining the result that the electronic file information 25a (or, 35a or 45a) does not include the electronic file related to the obtainment request, the access destination determining unit 73 first obtains a result obtained by inquiring of the distributed file management apparatus 10 about the server which holds the electronic file related to the obtainment request. Then, on the basis of the obtained result of the inquiry, the access destination determining unit 73 determines the access destination.

In this case here, when the server which holds the electronic file related to the obtainment request is present, the result of the inquiry includes information specifying this server. When no server holds the electronic file related to the obtainment request, the result of the inquiry includes a signal indicating that no server holds the electronic file related to the obtainment request.

Moreover, when the sender of the request is the terminal 60 (or 65) and the request is a write request, the access destination determining unit 73 obtains a result obtained by inquiring of the distributed file management apparatus 10 about the server which holds the electronic file related to the write request. Then, on the basis of the obtained result of the inquiry, the access destination determining unit 73 determines the access destination.

In this case here, when the server which holds the electronic file related to the write request is present, the result of the inquiry includes information indicating all the servers which hold the electronic file related to the write request. When no server holds the electronic file related to the obtainment request, the result of the inquiry includes a signal indicating that no server holds the electronic file related to the write request.

Up to this point, the specific determination made by the access destination determining unit 73 of the present embodiment has been described.

Also, when its own file storage unit 25 (or, 35 or 45) is included in the determined access destination, the access destination determining unit 73 requests its own file storage control unit 77 to perform processing related to the request of the user. To be more specific, in this case here, the access destination determining unit 73 is an example of a processing requesting unit which requests the access destination determined by the access destination determining unit to perform the processing related to the request of the user.

The write file holding unit 75 temporarily stores the electronic file to be written when the request receiving unit 71 receives a write request. The write file holding unit 75 is realized by a RAM (Random Access Memory), for example.

The file storage control unit 77 controls the file storage unit 25. The file storage control unit 77: searches and checks whether or not the file storage unit 25 stores a specific electronic file; reads the electronic file stored in the file storage unit 25; updates the electronic file stored in the file storage unit 25; stores a new electronic file to the file storage unit 25; and locks and unlocks the file storage unit 25 so that the access is allowed only when a specific instruction is given.

To be more specific, the file storage control unit 77 is an example of a write unit which writes an electronic file to the electronic file storage unit and then, after the completion of writing, notifies the completion judging unit 87 that the writing is completed. The completion judging unit 87 is described later as an example of a result obtaining unit.

When the access destination determining unit 73 judges that an inquiry needs to be made to the distributed file management apparatus 10, the access destination inquiring unit 79 sends the details of the request received by the request receiving unit 71 together with a signal inquiring as to an access destination corresponding to the details of the request, to the distributed file management apparatus 10 via the communication line 50.

The access destination receiving unit 81 receives, via the communication line 50, a response given by the distributed file management apparatus 10 to the inquiry made by the access destination inquiring unit 79. To be more specific, the access destination receiving unit 81 is an example of a holding server receiving unit which receives information concerning the holding server that is sent by an access destination responding unit 106. The access destination responding unit 106 is described later as an example of a holding server sending unit.

When the access destination determining unit 73 judges that access to a different server is needed, the processing requesting unit 83 requests, via the communication line 50, the different server, access to which is judged to be necessary, to perform processing related to the request received by the request receiving unit 71.

To be more specific, the processing requesting unit 83 is an example of a processing requesting unit which requests the access destination determined by the access destination determining unit 73 to perform processing related to the request of the user. The access destination determining unit 73 is an example of an access destination determining unit.

The result obtaining unit 85 obtains, via the communication line 50, a result of the requested processing from the different server the processing requesting unit 83 accesses. To be more specific, the result obtaining unit 85 is an example of a result obtaining unit which obtains, from the access destination, a result of processing requested by the processing requesting unit to be performed by the access destination.

The completion judging unit 87 judges whether or not the result of the processing has been obtained from each server, access to which is judged by the access destination determining unit 73 to be necessary.

The completion judging unit 87 of the present embodiment obtains information specifying all the servers, access to which is judged by the access destination determining unit 73 to be necessary, from the access destination determining unit 73, and then holds the obtained information. Then, the completion judging unit 87 judges whether or not the result of processing has been obtained from each of the servers, access to which is judged by the access destination determining unit 73 to be necessary, by comparing the information specifying all the holding servers and the information specifying the senders of the results obtained by the result obtaining unit 85. Here, all the servers to be judged by the completion judging unit 87 include the server which has the present completion judging unit 87.

To be more specific, the completion judging unit 87 is an example of a completion judging unit which judges that the processing related to the request of the user is completed when the result obtaining unit obtains the result of the processing related to the request of the user from each of the access destinations determined by the access destination determining unit.

When the access destination determining unit 73 determines that its own file storage unit 25 (or, 35 or 45) is the access destination related to the file writing, the completion judging unit 87 obtains the notification from its own file storage control unit 77 that the writing is completed, as the result of the processing related to the request of the user.

To be more specific, in this case here, the completion judging unit 87 is an example of a result obtaining unit which obtains, from the access destination, a result of the processing requested by the access destination determining unit 73 to be performed by the access destination. The access destination determining unit 73 is an example of a processing requesting unit,

When the necessary processing related to the request received by the request receiving unit 71 from the user is completed in each server, the completion notifying unit 89 notifies the distributed file management apparatus 10 that the necessary processing is completed in each server.

When the completion judging unit 87 judges that the result of the processing has been obtained from each of the servers, access to which is judged by the access destination determining unit 73 to be necessary, the completion notifying unit 89 of the present embodiment notifies of: the completion of the necessary processing in each server; all the accessed servers; and the executed processing for each server.

To be more specific, the completion notifying unit 89 is an example of a completion notifying unit which notifies the distributed file management apparatus of information concerning the access destination where the write processing has been performed in relation to the request from the user and of information concerning the electronic file when the completion judging unit judges that the processing related to the request from the user is completed.

The result sending unit 91 sends the result of the processing performed in response to the request received by the request receiving unit 71 to the sender of the request.

To be more specific, the result sending unit 91 is an example of a result sending unit which sends the result obtained by the result obtaining unit to the terminal. More specifically, the result sending unit 91 is an example of a result sending unit which sends the result of processing related to the request of the user to the terminal when the completion judging unit judges that the processing related to the request of the user is completed.

When the request receiving unit 71 receives a request from the terminal 60 or 65, the result sending unit 91 sends a result of processing to the terminal 60 or 65 which is the sender of the request, via the communication line 15. Moreover, when a request is received from the other server 30 or 40, the result sending unit 91 sends a result of processing to the server 30 or 40 which is the sender of the request, via the communication line 50.

Next, the distributed file management apparatus 10 includes a holding server storage unit 100, an inquiry receiving unit 102, a holding server determining unit 104, an access destination responding unit 106, a notification receiving unit 108, a holding information updating unit 110, and a control instruction sending unit 112.

The holding server storage unit 100 is a storage unit which stores: management server information concerning the servers set as the management objects of the distributed file management apparatus 10; and holding server information concerning the electronic files stored in the servers included in the management server information. The holding server storage unit 100 is realized by an HD (Hard Disk), for example.

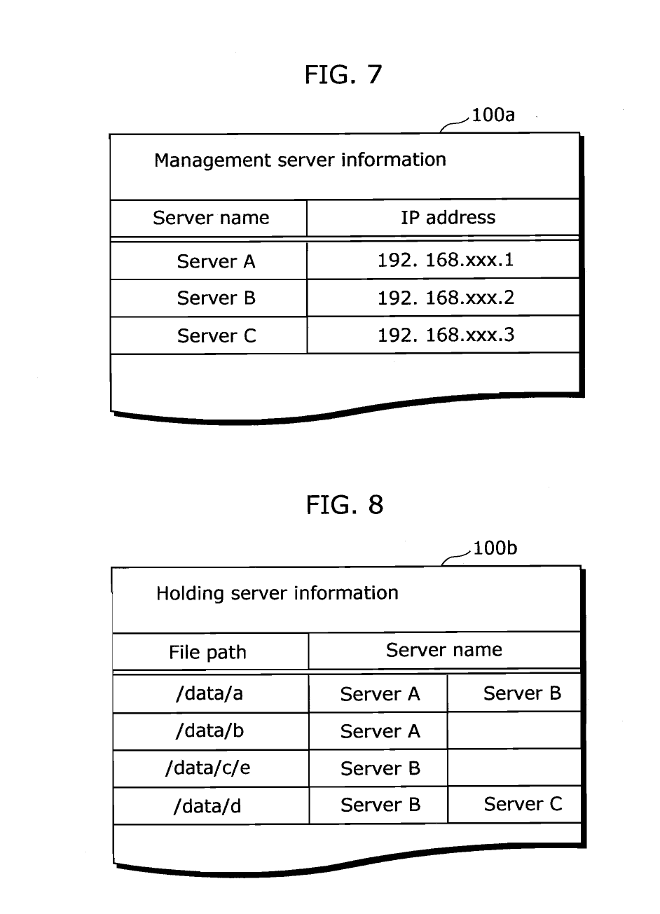

Here, specific examples of the management server information and the holding server information of the present embodiment are explained, with reference to FIGS. 7 and 8.

FIG. 7 is a diagram showing an example of management server information 100a stored in the holding server storage unit 100. As shown in this diagram, the management server information 100a of the present embodiment includes a “Server name” and an “IP address”.

A description of the “Server name” is a server name assigned to the server which is a management object of the distributed file management apparatus 10. A description of the “IP address” is an IP address assigned to the server. For each server which is a management object of the distributed file management apparatus 10, the management server information 100a stores the server name and the IP address in association with each other.

For example, this diagram shows that the server A20 is identified by “Server A” which is the “Server name” and its “IP address” is “192.168.xxx.1”.

FIG. 8 is a diagram showing an example of holding server information 100b stored in the holding server storage unit 100. As shown in this diagram, the holding server information 100b of the present embodiment includes a “File path” and a “Server name”. To be more specific, the holding server information 100b is an example of file location information whereas the holding server storage unit 100 is an example of a file location information storage unit.

A description of the “File path” is a path of an electronic file stored by a server. As explained with reference to FIG. 2, the paths of the electronic files are common to all the servers managed by the distributed file management apparatus 10.

A description of the “Server name” is a server name which is the same as the “Server name” of the management server information 100a. The “Server name” of the holding server information 100b is associated with the electronic file specified by the “File path”. As the “Server name” of the holding server information 100b, all the names of the servers which store the electronic file specified by the “File path” are stored.

For example, this diagram shows that the servers which hold the electronic file specified by the “File path” of “/data/a”, that is, a “file a”, are the server A20 and the server B30.

Here, the explanation returns to FIG. 6.

The inquiry receiving unit 102 receives an inquiry from the access destination inquiring unit 79 of the server that receives a request of the user, with the inquiry regarding a server related to the request of the user.

The inquiry receiving unit 102 of the present embodiment receives: details of the request of the user received by the server; the attribute information of the electronic file related to the request of the user; a request for determination and response as to a server having the electronic file related to the request of the user.

With reference to the management server information 100a and the holding server information 100b stored in the holding server storage unit 100, the holding server determining unit 104 determines and extracts the server and its IP address corresponding to the details of the inquiry received by the inquiry receiving unit 102, and then judges whether or not the file storage unit included in the determined and extracted server needs to be locked.

To be more specific, the holding server determining unit 104 is an example of a holding server determining unit which determines a holding server with reference to the file location information, in response to the inquiry from the access source server.

The access destination responding unit 106 responds to the server which is a source of the inquiry, and sends information, as a response, concerning the server determined and extracted by the holding server determining unit 104.

The access destination responding unit 106 of the present embodiment sends the information concerning the server determined and extracted by the holding server determining unit 104 to the server which is the inquiry source, and also sends the details of the request of the user received by the server and the attribute information of the electronic file related to the request of the user, the details and the attribute information being included in the inquiry received by the inquiry receiving unit 102.

To be more specific, the access destination responding unit 106 is an example of a holding server sending unit which sends the access source server the information concerning the holding server determined by the holding server determining unit.

The notification receiving unit 108 receives a notification, from the completion notifying unit 89 included in the server 20 (or, 30 or 40), that the processing related to the request of the user is completed, and then outputs information included in the notification to the holding information updating unit 110.

On the basis of the notification information received from the notification receiving unit 108, the holding information updating unit 110 updates the holding server information 100b stored in the holding server storage unit 100.

The holding information updating unit 110 of the present embodiment updates the description of the “File path” with reference to the processing performed by each server included in the notification information, and also updates the description of the “Server name” according to the updated description of the “File path” with reference to all the accessed servers included in the notification information.

To be more specific, the holding information updating unit 110 is an example of a location information updating unit which updates the file location information in accordance with the information concerning the access destinations and the information concerning the electronic file that are obtained from the completion notifying unit.

Receiving the result of the determination made by the holding server determining unit 104, the control instruction sending unit 112 sends each server an instruction to lock the file storage unit included in the server, and holds the information concerning these servers.

Moreover, receiving an instruction from the holding information updating unit 110, the control instruction sending unit 112 sends an instruction to unlock the file storage unit included in the server. Here, a sending destination of the unlock instruction is the server which received the lock instruction, and is held by the control instruction sending unit 112.

When judging that the file storage unit included in the server determined and extracted by the holding server determining unit 104 needs to be locked, the control instruction sending unit 112 of the present embodiment sends each server determined and extracted by the holding server determining unit 104 an instruction to lock the file storage unit included in the server.

When the holding information updating unit 110 finishes updating the holding server information 100b stored in the holding server storage unit, the control instruction sending unit 112 of the present embodiment sends each server, to which its own held lock instruction was sent, an instruction to unlock the file storage unit included in the server.

To be more specific, the control instruction sending unit 112 is an example of a lock instruction sending unit which, when the holding server determining unit judges that the request of the user is to write an electronic file and that a holding server is present, sends the holding server an instruction to lock the file storage unit included in the holding server.

Also, to be more specific, the control instruction sending unit 112 is an example of an unlock instruction sending unit which, when receiving a notification from the completion notifying unit, sends the holding server, to which the instruction was sent by the lock instruction sending unit, an instruction to unlock the file storage unit included in the holding server.

The server 20 (30 and 40) and the distributed file management apparatus 10 have the functions described so far, so that the distributed file management apparatus 10 can manage the electronic files held in the server 20 (30 and 40) which is the management object. Thus, even when the server receives a request from the user regarding an electronic file which is not stored in the server itself, the server can execute the processing related to the electronic file and accordingly respond to the request from the user.

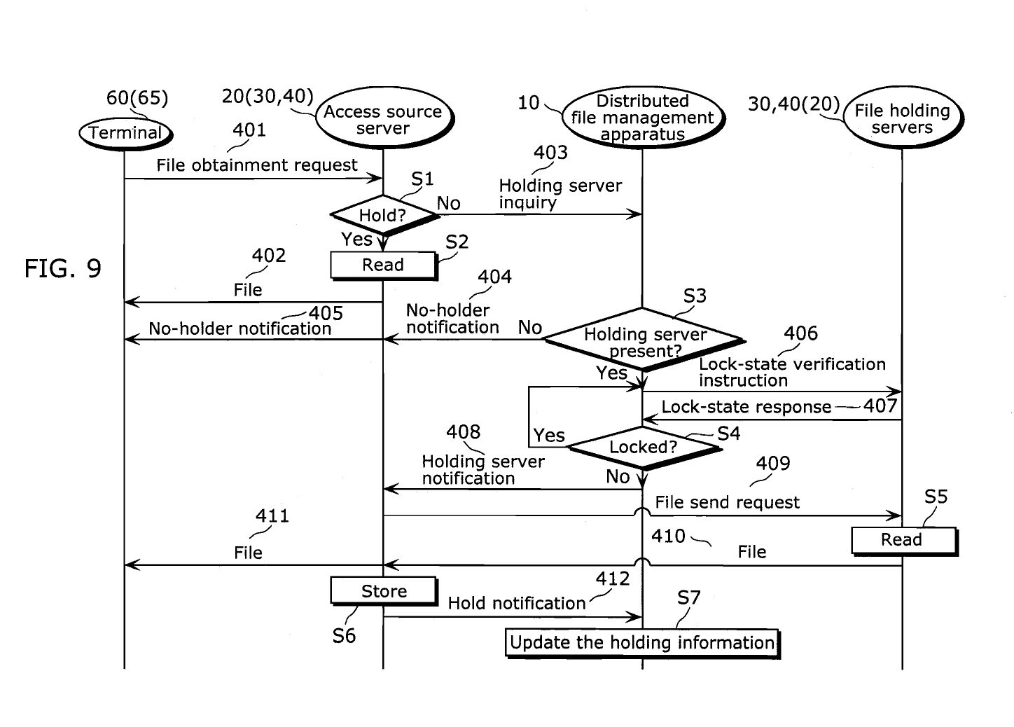

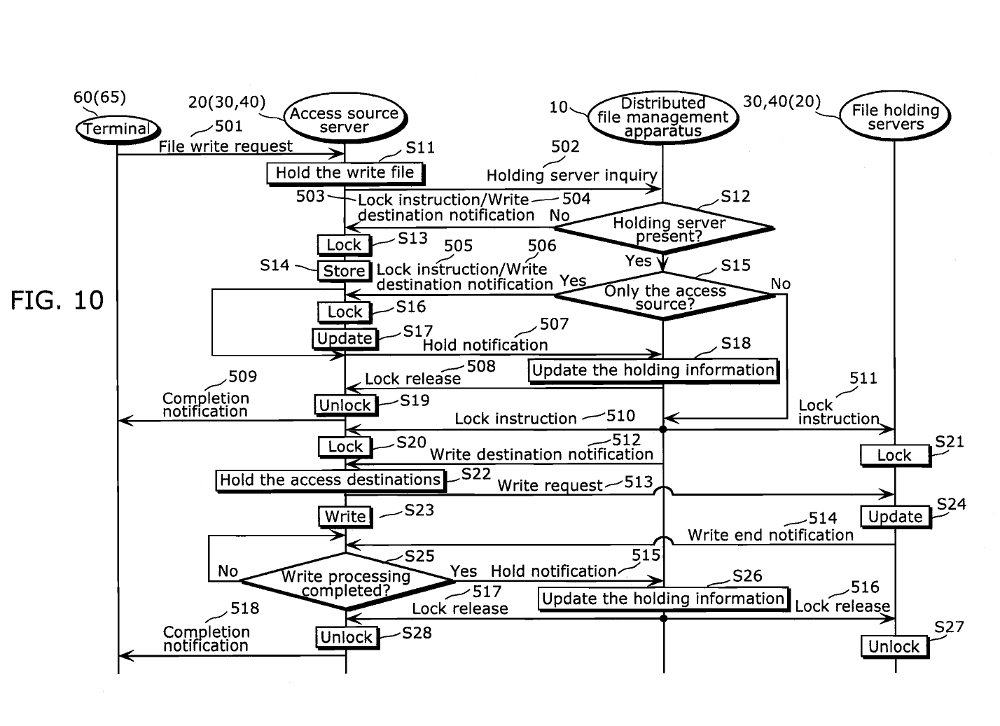

With reference to FIGS. 9 and 10, an explanation is given as to a series of processes executed by the distributed file management apparatus 10 and the servers 20, 30, and 40 when the user sends an obtainment request or a write request using the terminal 60 or 65.

FIG. 9 is a time chart showing examples of processing executed by the apparatuses included in the distributed file management system of the present embodiment and of information sent and received among the apparatuses, when the user sends a file obtainment request from the terminal.

A terminal shown in this diagram is used by the user, and is the terminal a60 or the terminal b65 in the present embodiment.

An access source server is a sending destination to which the terminal 60 (or 65) used by the user sends a request of the user. In the present embodiment, the access source server is one of the server A20, the server B30, and the server C40.

A file holding server (referred to as the “holding server” hereafter) holds an electronic file related to the request of the user, and is a server other than the access source server. In the present embodiment, the server A20, the server B30, or the server C40 can be a candidate for the holding server.

First, a file obtainment request 401 is sent from the terminal 60 (or 65) used by the user to the access source server 20 (or, 30 or 40). Then, the request receiving unit 71 of the access source server 20 (or, 30 or 40) receives the file obtainment request 401.

The file obtainment request 401 is a signal whose description represents a request to obtain a specific electronic file related to designation by the user.

Receiving the file obtainment request 401, the request receiving unit 71 sends the file obtainment request 401 and information specifying the sender to the access destination determining unit 73. In the present embodiment, the information specifying the sender is an address of the terminal 60 (or 65), for example.

Obtaining the file obtainment request 401 and the address specifying the sender, the access destination determining unit 73 judges that the request obtained from the request receiving unit 71 is the file obtainment request 401 sent from the terminal 60 (or 65), and judges whether or not its own file storage unit 25 (or, 35 or 45) holds the electronic file related to the file obtainment request 401 (S1).

The details of this judgment processing (S1) are explained as follows.

First, the access destination determining unit 73 causes the file storage control unit 77 to search whether or not the electronic file information 25a (or, 35a or 45a) stored in its own file storage unit 25 (or, 35 or 45) includes the electronic file related to the file obtainment request 401.

Next, the access destination determining unit 73 obtains a result of the search from the file storage control unit 77.

When the obtained search result shows that the electronic file information 25a (or, 35a or 45a) includes the electronic file related to the file obtainment request 401, the access destination determining unit 73 judges that its own file storage unit 25 (or, 35 or 45) holds the electronic file related to the file obtainment request (Yes in S1).

Meanwhile, when the obtained search result shows that the electronic file information 25a (or, 35a or 45a) does not include the electronic file related to the file obtainment request 401, the access destination determining unit 73 judges that its own file storage unit 25 (or, 35 or 45) does not hold the electronic file related to the file obtainment request (No in S1).

Up to this point, the explanation has been given about the details of the judgment (S1) made as to whether or not the access source server 20 (or, 30 or 40) itself holds the electronic file related to the file obtainment request 401.

First, when the access destination determining unit 73 judges that its own file storage unit 25 (or, 35 or 45) stores the electronic file related to the file obtainment request 401 (Yes in S1), the file storage control unit 77 reads, in response to the instruction from the access destination determining unit 73, the electronic file related to the file obtainment request 401 from the electronic file information 25a (or, 35a or 45a) of the file storage unit 25 (or, 35 or 45) (S2).

Obtaining the electronic file read by the file storage control unit 77 from the file storage control unit 77, the access destination determining unit 73 sends the electronic file and the address specifying the sender of the file obtainment request 401 to the result sending unit 91.

Obtaining the electronic file and the address specifying the sender of the file obtainment request 401 from the access destination determining unit 73, the result sending unit 91 sends a file 402 to this address and then terminates the processing.

The file 402 is a signal whose content is the electronic file related to the file obtainment request 401.

In this way, when receiving the file obtainment request 401 requesting the electronic file stored in itself, the access source server 20 (or, 30 or 40) obtains the electronic file related to the file obtainment request 401 by accessing its own file storage unit 25 (or, 35 or 45) and sends the obtained electronic file to the terminal 60 (or 65) used by the user.

In this case here, unlike the case where the file obtainment request 401 requesting an electronic file which is not stored in itself is received as described later, the access source server 20 (or, 30 or 40) does not need to access the distributed file management apparatus 10 or the other server 30 (or, 40 or 20). On account of this, the access source server 20 (or, 30 or 40) can send the file 402 more speedily.

Next, when the access destination determining unit 73 judges that its own file storage unit 25 (or, 35 or 45) does not store the electronic file related to the file obtainment request 401 (No in S1), the access destination inquiring unit 79 sends a holding server inquiry 403 to the distributed file management apparatus 10 in response to the instruction from the access destination determining unit 73.

The holding server inquiry 403 is a signal whose description represents an inquiry about a server that holds the electronic file related to the file obtainment request 401.

The inquiry receiving unit 102 receives the holding server inquiry 403. Receiving the holding server inquiry 403, the inquiry receiving unit 102 sends the holding server inquiry 403 to the holding server determining unit 104.

Obtaining information specifying the access source server 20 (or, 30 or 40) and the holding server inquiry 402 from the inquiry receiving unit 102, the holding server determining unit 104 judges whether or not such a holding server is present by reference to the holding server information 100b stored in the holding server storage unit 100 (S3).

To be more specific, when: information specifying the electronic file related to the request of the user is included; and information specifying the server associated with the information specifying the electronic file is present, the holding server determining unit 104 judges that the holding server is present (Yes in S3). In cases other than this, the holding server determining unit 104 judges that such a holding server is not present (No in S3).

First, when it is judged that the holding server is not present (No in S3), the access destination responding unit 106 sends a no-holder notification 404 to the access source server 20 (or, 30 or 40) in response to the judgment made by the holding server determining unit 104.

The no-holder notification 404 is a signal whose description represents that no holding server is present.

The access destination receiving unit 81 obtains the no-holder notification 404 as a result of the inquiry made to the distributed file management apparatus 10. Obtaining the no-holder notification 404, the access destination receiving unit 81 sends the no-holder notification 404 to the access destination determining unit 73.

Obtaining the no-holder notification 404, the access destination determining unit 73 judges that the processing related to the file obtainment request 401 is completed since the no-holder notification 404 is obtained in response to the file obtainment request 401. Then, the access destination determining unit 73 sends the result sending unit 91: the address specifying the terminal 60 (or 65) which is the sender of the file obtainment request 401; and the no-holder notification 404.

In response to the instruction from the access destination determining unit 73, the result sending unit 91 sends a no-holder notification 405 to the obtained address, and then terminates the processing.

The no-holder notification 405 is a signal whose description represents that no holding server is present.

Next, when it is judged that the holding server is present (Yes in S3), the holding server determining unit 104 reads the IP addresses of the holding servers 30 and 40 (or, 20) by reference to the management server information 100a.

Reading the IP addresses of the holding servers, the holding server determining unit 104 sends the read IP addresses to the control instruction sending unit 112.

In response to the instruction from the holding server determining unit 104, the control instruction sending unit 112 sends a lock-state verification instruction 406 to the obtained IP addresses.

The lock-state verification instruction 406 is a signal used for verifying that the file storage units 35 and 45 (or 25) included in the holding servers 30 and 40 (or 20) are locked.

Each of the file storage control units 77 receives the lock-state verification instruction 406. Receiving the lock-state verification instruction 406, the file storage control unit 77 sends a lock-state response 407.

The lock-state response 407 is a signal whose description represents whether or not the file storage units 35 and 45 (or 25) included in the holding servers 30 and 40 (or 20) which received the lock-state verification instruction 406 are locked.

The control instruction sending unit 112 receives the lock-state response 407. Receiving the lock-state response 407, the control instruction sending unit 112 judges, from the details of the lock-state response 407, whether or not the file storage units 35 and 45 (or 25) included in the holding servers 30 and 40 (or 20) are locked (S4). When judging that they are locked (Yes in S4), the control instruction sending unit 112 sends the lock-state verification instruction 406 once again.

When judging that they are not locked (No in S4), the control instruction sending unit 112 notifies the holding server determining unit 104 that the file storage units 35 and 45 (or 25) included in the holding servers 30 and 40 (or 20) are not locked.

Receiving this notification, the holding server determining unit 104 sends the access destination responding unit 106: the IP address of the access source server; the IP addresses of the holding servers; and the holding server inquiry 403.

Receiving the instruction from the holding server determining unit 104, the access destination responding unit 106 sends a holding server notification 408 to the IP address of the access source server.

The holding server notification 408 is a signal whose content is the holding server inquiry 403 and the IP addresses of the holding servers.

The access destination receiving unit 81 receives the holding server notification 408. Receiving the holding server notification 408, the access destination receiving unit 81 sends the holding server notification 408 to the access destination determining unit 73.

The access destination determining unit 73 judges that the holding servers 30 and 40 (or 20) included in the holding server notification 408 are the access destinations related to the electronic file obtainment relevant to the file obtainment request 401.

Judging that the holding servers 30 and 40 (or 20) are the access destinations, the access destination determining unit 73 sends a file send request 409 to the IP addresses of the holding servers 30 and 40 (or 20).

The file send request 409 is a signal whose description represents a request to send the electronic file related to the file obtainment request 401 to the access source server 20 (or, 30 or 40).

Each of the request receiving units 71 of the holding servers 30 and 40 (or 20) receives the file send request 409.

From the request receiving unit 71, each of the access destination determining units 73 of the holding servers 30 and 40 (or 20) obtains the file send request 409 and information specifying the sender of the request, such as the IP address of the access source server 20 (or, 30 or 40).

Each of the access destination determining units 73 of the holding servers 30 and 40 (or 20) judges that its own file storage unit 35 or 45 (or 25) is the access destination since the request received by its own request receiving unit 71 is the file send request 409 sent from the server 20 (or, 30 or 40).

In response to the instruction from its own access destination determining unit 73, each of the file storage control units 77 of the holding servers 30 and 40 (or 20) reads the electronic file related to the file send request 409 from the electronic file information 35a or 45a (or 25a) of its own file storage unit 35 or 45 (or 25) (S5).

Obtaining the electronic file read by its own file storage control unit 77 from its own file storage control unit 77, each of the access destination determining units 73 of the holding servers 30 and 40 (or 20) sends the result sending unit 91: the read electronic file; the file send request 409; and the address specifying the sender of the file send request 409.

Each of the result sending units 91 of the holding servers 30 and 40 (or 20) obtains the electronic file, the file send request 409, and the address specifying the sender of the file send request 409 from its own access destination determining unit 73, and sends the file send request 409 and a file 410 to this address.

The file 410 is a signal whose content is the electronic file related to the file send request 409.

The result obtaining unit 85 of the access source server 20 (or, 30 or 40) obtains the file send request 409 and the file 410 as a result of the inquiry made to the distributed file management apparatus 10. Receiving the file send request 409 and the file 410, the result obtaining unit 85 sends the file send request 409 and the file 410 to the completion judging unit 87.

Obtaining the file send request 409 and the file 410, the completion judging unit 87 obtains, from the access destination determining unit 73, the details of the file obtainment request 401 related to the file send request 409 and the address of the terminal 60 (or 65) which is the sender of the file obtainment request 401.

Moreover, the access destination determining unit 73 judges that its own file storage unit 25 (or, 35 or 45) is the access destination because the file which is not stored in its own file storage unit 25 (or, 35 or 45) is obtained. Thus, the completion judging unit 87 obtains a result of this judgment as well.

Obtaining these, the completion judging unit 87 first sends, since the file 410 is obtained in response to the file obtainment request 401, the address of the terminal 60 (or 65) which is the sender of the file obtainment request 401 and the file 410 to the result sending unit 91.

Receiving the instruction from the completion judging unit 87, the result sending unit 91 sends a file 411 to the obtained address.

The file 411 is the same as the file 410 and, therefore, is an electronic file related to the file obtainment request 401.

Moreover, obtaining these, the completion judging unit 87 next sends the file 410 to the file storage control unit 77 since its own file storage unit 25 (or, 35 or 45) is the access destination.

In response to the instruction from the completion judging unit 87, the file storage control unit 77 stores the obtained file 410 in the electronic file information 25a (or, 35a or 45a) of the file storage unit 25 (or, 35 or 45) (S6).

After storing the obtained file 410, the file storage control unit 77 notifies the completion judging unit 87 that store processing of the file 410 is finished.

Receiving the notification that the store processing of the file 410 is finished, the completion judging unit 87 judges that the processing related to the file obtainment request 401 is completed. Judging that the processing related to the file obtainment request 401 is completed, the completion judging unit 87 notifies the completion notifying unit 89 that the file 410 is stored in the file storage unit 25 (or, 35 or 45) of the access source server 20 (or, 30 or 40).

Receiving the notification that the file 410 is stored in the file storage unit 25 (or, 35 or 45), the completion notifying unit 89 sends a hold notification 412 to the distributed file management apparatus 10 and then terminates the processing.

The hold notification 412 is a signal whose description represents that the access source server 20 (or, 30 or 40) holds the file 410.

The notification receiving unit 108 receives the hold notification 412. Receiving the hold notification 412, the notification receiving unit 108 sends the hold notification 412 to the holding information updating unit 110.

In accordance with the obtained hold notification 412, the holding information updating unit 110 updates the holding server information 100b (S7), and then terminates the processing. To be more specific, the processing of updating the holding server information 100b in this case here is processing of adding the name of the access source server to the “Server name” whose “File path” is the file 410.

As described so far, when the access source server 20 (or, 30 or 40) receives a request, from the terminal 60 (or 65), to obtain an electronic file which is not stored in the server itself and one or more of the servers 30 and 40 (or 20) which are the management objects of the distributed file management apparatus 10 store the electronic file related to the present obtainment request, the access source server 20 (or, 30 or 40) can obtain the electronic file related to the obtainment request from one or more of the holding servers 30 and 40 (or 20).

Even in this case, in terms of the interface and the processing of the terminal, the user does not need to think about which server has the desired electronic file.

Moreover, the access source server 20 (or, 30 or 40) stores the electronic file obtained from the holding servers 30 and 40 (or 20) in its own file storage unit 25 (or, 35 or 45). On account of this, when receiving an obtainment request related to the same electronic file from the user again, the access source server 20 (or, 30 or 40) can respond to the request more speedily.

FIG. 10 is a time chart showing examples of processing executed by the apparatuses included in the distributed file management system according to the present embodiment and of information sent and received among the apparatuses, when the user sends a file write request from the terminal.

Significances of the terminal 60 (or 65), the access source server 20 (or, 30 or 40), the distributed file management apparatus 10, and the holding servers 30 and 40 (or 20) and a relation among these shown in this diagram are the same as those in the case of the terminal 60 (or 65), the access source server 20 (or, 30 or 40), the distributed file management apparatus 10, and the holding servers 30 and 40 (or 20) shown in FIG. 9. Therefore, the explanation is omitted here.

First, a file write request 501 is sent to the access source server 20 (or, 30 or 40) from the terminal 60 (or 65) used by the user.

The file write request 501 is a signal whose description represents a request to write a specific electronic file designated by the user.

Next, the request receiving unit 71 included in the access source server 20 (or, 30 or 40) receives the file write request 501.

Receiving the file write request 501, the request receiving unit 71 sends the file write request 501 and information specifying the sender of the request 501 to the access destination determining unit 73. In the present embodiment, the information specifying the sender is the address of the terminal 60 (or 65) as an example.

Obtaining the file write request 501 and the address of the sender of the request 501, the address destination determining unit 73 stores a new electronic file related to the file write request 501 in the write file holding unit 75 because the request received from the request receiving unit 71 is the file write request 501 sent from the terminal 60 (or 65) (S11).

Obtaining the file write request 501 and the address of the sender of the request 501, the address destination determining unit 73 next sends the file write request 501 to the access destination inquiring unit 79.

Obtaining the file write request 501, the access destination inquiring unit 79 sends a holding server inquiry 502 to the distributed file management apparatus 10.

The holding server inquiry 502 is a signal whose description represents an inquiry about a server that holds the electronic file related to the file write request 501.

The inquiry receiving unit 102 receives the holding server inquiry 502. Receiving the holding server inquiry 502, the inquiry receiving unit 102 sends the holding server inquiry 502 to the holding server determining unit 104.

Obtaining the information specifying the access source server 20 (or, 30 or 40) and the holding server inquiry 402 from the inquiry receiving unit 102, the holding server determining unit 104 judges whether or not such a holding server is present, by reference to the holding server information 100b stored in the holding server storage unit 100 (S12). Details of this judgment (S12) as to the presence or absence of the holding server is the same as the judgment (S3) shown in FIG. 9 as to the presence or absence of the holding server, and thus the explanation is omitted here.

First, when it is judged that the holding server is not present (No in S12), the control instruction sending unit 112 sends a lock instruction 503 to the access source server 20 (or, 30 or 40) in response to the judgment made by the holding server determining unit 104.

The lock instruction 503 is a signal whose description represents an instruction to lock the file storage unit 25 (or, 35 or 45) of the access source server 20 (or, 30 or 40) so that the file storage unit 25 (or, 35 or 45) receives a write instruction only from the subsequently-connected distributed file management apparatus 10.

The file storage control unit 77 receives the lock instruction 503. Receiving the lock instruction 503, the file storage control unit 77 locks the file storage unit 25 (or, 35 or 45) related to the present control, in accordance with the lock instruction 503 (S13).

Following the transmission of the lock instruction 503 by the control instruction sending unit 112, the access destination responding unit 106 sends a write destination notification 504 to the access source server 20 (or, 30 or 40).

Since there is no server related to the holding server inquiry 502 that holds the electronic file related to the file write request 501, the write destination notification 504 is a signal whose description represents that a storage destination of the new electronic file is only its own file storage unit 25 (or, 35 or 45).

The access destination receiving unit 81 receives the write destination notification 504. Receiving the write destination notification 504, the access destination receiving unit 81 sends the write destination notification 504 to the access destination determining unit 73.

From the write destination notification 504, the access destination determining unit 73 judges that the access destination related to the file write request 501 is only its own file storage unit 25 (or, 35 or 45).

Judging that the access destination is only its own file storage unit 25 (or, 35 or 45), the access destination determining unit 73 outputs a write instruction based on the write destination notification 504 to its own file storage control unit 77.

Obtaining the write instruction based on the write destination notification 504, the file storage control unit 77 obtains the electronic file related to the write destination notification 504 from the write file holding unit 75, and stores the obtained electronic file in the file storage unit 25 (or, 35 or 45) (S14).

Next, when it is judged that the holding server is present (No in S12), the holding server determining unit 104 further judges whether or not the holding server is only the access source server 20 (or, 30 or 40) (S15).

When it is judged that the holding server is only the access source server 20 (or, 30 or 40) (Yes in S15), the control instruction sending unit 112 first sends a lock instruction 505 to the access source server 20 (or, 30 or 40) in response to the judgment made by the holding server determining unit 104.

The lock instruction 505 is a signal whose description is the same as that of the lock instruction 503.

Receiving the lock instruction 505, the file storage control unit 77 performs the same processing as in S13, and locks the file storage unit 25 (or, 35 or 45) in accordance with the lock instruction 505 (S16).

Following the transmission of the lock instruction 505 by the control instruction sending unit 112, the access destination responding unit 106 sends a write destination notification 506 to the access source server 20 (or, 30 or 40).

Since only the access source server 20 (or, 30 or 40) is the server related to the holding server inquiry 502 that holds the electronic file related to the file write request 501, the write destination notification 506 is a signal whose description represents that a storage destination of the new electronic file is only its own file storage unit 25 (or, 35 or 45).

The access destination receiving unit 81 receives the write destination notification 506. Receiving the write destination notification 506, the access destination receiving unit 81 sends the write destination notification 506 to the access destination determining unit 73.

From the write destination notification 506, the access destination determining unit 73 judges that the access destination related to the file write request 501 is only its own file storage unit 25 (or, 35 or 45).

Judging that the access destination is only its own file storage unit 25 (or, 35 or 45), the access destination determining unit 73 outputs a write instruction based on the write destination notification 506 to its own file storage control unit 77.

Obtaining the write instruction based on the write destination notification 506, the file storage control unit 77 obtains the electronic file related to the write destination notification 506 from the write file holding unit 75, and updates the file storage unit 25 (or, 35 or 45) (S17).

The update processing in this case here refers to processing of, for example, overwriting the information except the file name out of the information included in the electronic file, that is, overwriting the entity of the electronic file and the data and time of creation of the electronic file that have been held by the file storage unit 25 (or, 35 or 45).

Upon completion of the writing according to the write destination notification 506, the file storage control unit 77 notifies the completion judging unit 87 that the writing according to the write destination notification 506 is finished.

Receiving the notification that the writing according to the write destination notification 506 is finished, the completion judging unit 87 judges that the processing related to the file write request 501 is completed. Judging that the processing related to the file write request 501 is completed, the completion judging unit 87 notifies the completion notifying unit 89 that the electronic file related to the file write request 501 is updated in the file storage unit 25 (or, 35 or 45) of the access source server 20 (or, 30 or 40).

Receiving the notification that the electronic file related to the file write request 501 that is held in the file storage unit 25 (or, 35 or 45) is updated, the completion notifying unit 89 sends a hold notification 507 to the distributed file management apparatus 10.

The hold notification 507 is a signal whose description represents that the electronic file related to the file write request 501 is updated.

The notification receiving unit 108 receives the hold notification 507. Receiving the hold notification 507, the notification receiving unit 108 sends the hold notification 507 to the holding information updating unit 110.

In accordance with the obtained hold notification 507, the holding information updating unit 110 updates the holding server information 100b (S18).

To be more specific, the processing of updating the holding server information 100b in this case here is processing of updating the attribute information of the electronic file related to the “File path” corresponding to the electronic file related to the file write request 501.

Finishing the update processing (S18), the holding information updating unit 110 notifies the control instruction sending unit 112 that the update processing related to the file write request 501 is finished. Obtaining the notification that the update processing related to the file write request 501 is finished, the control instruction sending unit 112 sends a lock release 508 to the access source server 20 (or, 30 or 40).

The lock release 508 is a signal whose description represents that the lock executed following the lock instruction 503 or 505 related to the file write request 501 is released.

The file storage control unit 77 receives the lock release 508. Receiving the lock release, the file storage control unit 77 unlocks the file storage unit 25 (or, 35 or 45) related to the present control (S19).

Releasing the lock, the file storage control unit 77 notifies the completion judging unit 87 that the lock related to the file write request 501 is released.

Obtaining the notification that the lock related to the file write request 501 is released, the completion judging unit 87 judges that the write processing related to the file write request 501 is finished and notifies the result sending unit 91 of this.

It should be noted that the completion judging unit 87 may judge that the write processing related to the file write request 501 is finished by receiving the notification that the electronic file related to the file write request 501 is updated, and may notify the result sending unit 91 of this.

The result sending unit 91 sends a completion notification 509 to the terminal which is the sender of the request, and then terminates the processing.

The completion notification 509 is a signal whose description represents that the processing related to the file write request 501 is finished.

When it is judged that the holding server is not only the access source server 20 (or, 30 or 40) (No in S15), the holding server determining unit 104 obtains the IP addresses of the holding servers by reference to the management server information 100a stored in the holding server storage unit 100.

The holding servers in this case here refer to all the servers which hold the electronic file related to the file write request 501.

From the holding server determining unit 104, the control instruction sending unit 112 receives: the IP address of the access source server 20 (or, 30 or 40) which is the sender of the file write request 501; the IP addresses of the holding servers; and an instruction to send lock instructions 510 and 511. First, the control instruction sending unit 112 sends the lock instruction 510 to the access source server 20 (or, 30 or 40).

The lock instruction 510 is a signal whose description is the same as that of the lock instruction 503.

The file storage control unit 77 receives the lock instruction 510. Receiving the lock instruction 510, the file storage control unit 77 locks the file storage unit 25 (or, 35 or 45) related to the present control, in accordance with the lock instruction 510 (S20).

The control instruction sending unit 112 next sends the lock instruction 511 to the holding servers 30 and 40 (or 20).

Here, when the number of the holding servers is more than one, the control instruction sending unit 112 sends the lock instruction 511 to all of the holding servers. Note that, however, when the access source server 20 (or, 30 or 40) is the holding server, the control instruction sending unit 112 sends the lock instruction 511 to all the holding servers except the access source server 20 (or, 30 or 40).

The lock instruction 511 is a signal whose description represents an instruction to lock the file storage unit 25 (or, 35 or 45) of the access source server 20 (or, 30 or 40) so that the file storage unit 25 (or, 35 or 45) receives a write instruction only from the subsequently-connected access source server 20 (or, 30 or 40).

Each of the file storage control units 77 of the holding servers 30 and 40 (or 20) receives the lock instruction 511. Receiving the lock instruction 511, the file storage control unit 77 locks the file storage unit 25 (or, 35 or 45) related to the present control, in accordance with the lock instruction 511 (S21).

After the control instruction sending unit 112 sends the lock instructions 510 and 511, the access destination responding unit 106 receives, from the holding server determining unit 104, a signal whose content is: information concerning the holding servers 30 and 40 (or 20), such as the IP addresses of the holding servers 30 and 40 (or 20); the IP address of the access source server 20 (or, 30 or 40); and a description representing that this is a response to the file write request 501.

The access destination responding unit 106 sends a write destination notification 512 to the access source server 20 (or, 30 or 40).

The write destination notification 512 is a signal whose content is: the information concerning the holding servers 30 and 40 (or 20), such as the IP addresses of the holding servers 30 and 40 (or 20); and a description representing that this is a response to the file write request 501.

The access destination receiving unit 81 receives the write destination notification 512. Receiving the write destination notification 512, the access destination receiving unit 81 sends the received write destination notification 512 to the access destination determining unit 73.

From the obtained write destination notification 512, the access destination determining unit 73 judges that the file storage units 25 (and, 35 and 45) of the holding servers and of its own are the access destinations. In the present embodiment, regardless of whether or not the access source server itself is the holding server, the electronic file related to the file write request 501 is always stored in the file storage unit 25 (or, 35 or 45) included in the access source server.

The access destination determining unit 73 notifies the completion judging unit 87 of the access destinations related to the file write request 501, and then the completion judging unit 87 temporarily holds the obtained access destinations related to the file write request 501 (S22).

Meanwhile, the access destination determining unit 73 outputs the electronic file related to the file write request 501 and an instruction to update or newly store this electronic file, to its own file storage control unit 77.

In accordance with the instruction received from the access source determining unit 73, the file storage control unit 77 updates or newly store the electronic file related to the file write request 501 in the file storage unit 25 (or, 35 or 45) (S23).

After finishing the update or newly-store processing (S23), the file storage control unit 77 notifies the completion judging unit 87 that the processing performed on its own file storage unit 25 (or, 35 or 45), which is one of the access destinations, is completed.

On the other hand, the access destination determining unit 73 sends the processing requesting unit 83 the IP addresses of the holding servers 30 and 40 (or 20) other than the IP address of the access source server 20 (or, 30 or 40) which are related to the write request 501.

Obtaining the IP addresses of the holding servers related to the write request 501, the processing requesting unit 83 obtains the electronic file related to the write request 501 from the write file holding unit 75 and sends a write request 513 to the holding servers 30 and 40 (or 20).

The write request 513 is a signal whose content is the electronic file related to the write request 501 and an instruction to store the present electronic file.

Each of the request receiving units 71 of the holding servers 30 and 40 (or 20) receives the write request 513. Receiving the write request 513, the request receiving unit 71 sends the received write request 513 and the information specifying the access source server 20 (or, 30 or 40) which is the sender of the write request 513, to the access destination determining unit 73.

The access destination determining units 73 of the holding servers 30 and 40 (or 20) judge that their own file storage units 35 and 45 (or 25) are the access destinations because the sender of the write request 513 is the other server.

On the basis of the judgment made by itself, each of the access destination determining units 73 of the holding servers 30 and 40 (or 20) outputs, to the file storage control unit 77, the electronic file related to the write request 513 and an instruction to update the present electronic file.

Each of the file storage control units 77 of the holding servers 30 and 40 (or 20) receives the electronic file related to the write request 513 and the instruction to update the present electronic file. Moreover, in accordance with the received instruction to update the electronic file, the file storage control units 77 update, using the electronic file related to the write request 513, the electronic file information 35a and 45a (or 25a) respectively stored in the file storage units 35 and 45 (or 25) which are under their own control (S24).

After the end of the update processing (S24), the file storage control unit 77 notifies the access destination determining unit that the processing of updating the electronic file related to the write request 513 is finished. Then, the access destination determining unit notifies the result sending unit 91 of the notified end of the processing of updating the electronic file related to the write request 513.

Receiving the end of the processing of updating the electronic file related to the write request 513, the result rending unit 91 sends a write end notification 514 to the access source server 20 (or, 30 or 40).

The write end notification 514 is a signal whose description represents that the processing related to the write request 513 sent to the access source server 20 (or, 30 or 40) is finished in the present holding servers 30 and 40 (or 20).

The result obtaining unit 85 of the access source server 20 (or, 30 or 40) obtains the write end notification 514. The result obtaining unit 85 sends the obtained write end notification 514 to the completion judging unit 87.

The completion judging unit 87 judges whether or not the write processing related to the write request 513 is completed (S25). To do so, the completion judging unit 87 judges, by reference to the self-stored access destinations, whether or not the end notification has been received from each of the access destinations.

When judging that the write processing is not completed (No in S25), the completion judging unit 87 continues to receive the end notification from the access destinations.

When judging that the write processing is completed (Yes in S25), the completion judging unit 87 instructs the completion notifying unit 89 to send a hold notification 515.

The hold notification 515 is a signal whose description represents that the update or newly-store processing is performed on the file storage units 25, 35, and 45 of all the access destination servers using the electronic file related to the write request 501.

The notification receiving unit 108 receives the hold notification 515. Receiving the hold notification 515, the notification receiving unit 108 sends the hold notification 515 to the holding information updating unit 110.

In accordance with the description of the hold notification 515, the holding information updating unit 110 updates the holding server information 100b of the holding server storage unit 100 (S26). The updated details in this case are: that the corresponding electronic file has been updated; and that the access source server 20 (or, 30 or 40) has become a holding server in the case where the access source server 20 (or, 30 or 40) was not a holding server.

After updating the holding server information 100b, the holding information updating unit 110 notifies the control instruction sending unit 112 that the update of the holding server information 100b is completed.

The control instruction sending unit 112 sends lock releases 516 and 517 to the servers related to the update of the holding server information 100b, that is, all of the access destination servers 20, 30, and 40. Then, the control instruction sending unit 112 terminates the processing.

The file storage control units 77 of the access destination servers 20, 30, and 40 receive the lock releases 516 and 517, and then unlock the file storage units 25, 35, and 45 which are respectively under the control of the file storage control units 77 (S27 and S28).

After the lock release (S28), the file storage control unit 77 of the access source server 20 (or, 30 or 40) outputs the lock release to the completion judging unit 87. The completion judging unit 87 notifies the result sending unit 91, as a result, that the processing related to the file write request 501 is completed.

In accordance with the result received from the completion judging unit 87, the result sending unit 91 sends a completion notification 518 to the terminal which is the sender of the file write request 501, and then terminates the processing.

As with the completion notification 509, the completion notification 518 is a notification whose description represents that the write processing related to the file write request 501 is completed.

The terminal which is the sender of the file write request 501 receives the completion notification 518.

With this, the user who uses the terminal can see that the processing related to the file write request 501 is completed through a display on a monitor or the like connected to the terminal.

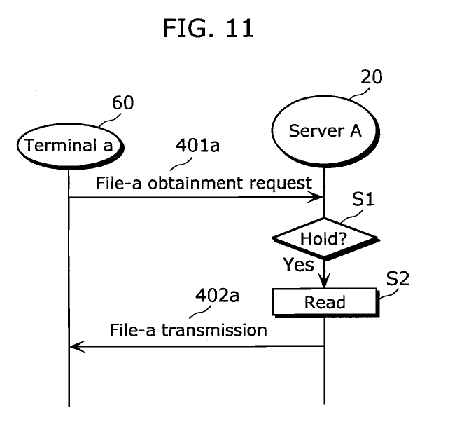

Up to this point, the explanation has been given as to a flow of a series of processes executed by the terminal, the servers, and the distributed file management apparatus according to the present embodiment. More specific examples of these processes are explained, with reference to FIGS. 11 to 30.

Here, it should be noted that, in FIGS. 11 to 30, the initial states of the electronic file information 25a, 35a, and 45a respectively stored in the file storage units 25, 35, and 45 included in the servers 20, 30, and 40 are as shown in FIGS. 3, 4, and 5 respectively.

Also note that, in FIGS. 11 to 30, the user uses the terminal a60 and sends a request to the server A20 from the terminal a60.

Moreover, in FIGS. 11 to 30, the “file x” refers to the electronic file information related to the file name “x”, as described above.

Furthermore, in FIGS. 11 to 30, “file x_2” refers to the electronic file information related to the updated file x, that is, the electronic file information whose file name is “x” and whose electronic file information, except the file name, related to the “file x” has been updated.

FIG. 11 is a time chart of a case where the user using the terminal a60 sends the server A20 a request to obtain a file a.

First, a file-a obtainment request 401a is sent from the terminal 60 to the access source server 20 (or, 30 or 40). The file-a obtainment request 401a is a signal whose description represents a request to obtain the file a.

Next, the request receiving unit 71 included in the server A20 receives the file-a obtainment request 401a. Receiving the file-a obtainment request 401a, the request receiving unit 71 sends the file-a obtainment request 401a and the address of the terminal 60 which is the sender of the request 401a, to the access destination determining unit 73.

Moreover, the access destination determining unit 73 judges that the request obtained from the request receiving unit 71 is the file-a obtainment request 401a from the terminal 60, and judges whether or not its own file storage unit 25 holds the file a (S1).

Here, as shown in FIG. 3, the file storage unit 25a holds the file a. Thus, the access destination determining unit 73 judges that its own file storage unit 25 holds the file a (Yes in S1).

In response to the instruction from the access destination determining unit 73, the file storage control unit 77 reads the file a from the electronic file information 25a (S2).

After obtaining the file a from the file storage control unit 77, the access destination determining unit 73 sends the file a and the address of the terminal a60 to the result sending unit 91.

The results sending unit 91 performs a transmission 402a to send the file a to the address of the terminal a60, and then terminates the processing.

Accordingly, the processing related to the file-a obtainment request is terminated. In this way, when the request is to obtain an electronic file which is held by the access source server, the access source server does not need to make reference to the holding server information 100b and thus does not need to write to its own electronic file information 25a and the holding server information 100b. On account of this, it is possible to speedily respond to the request of the user.

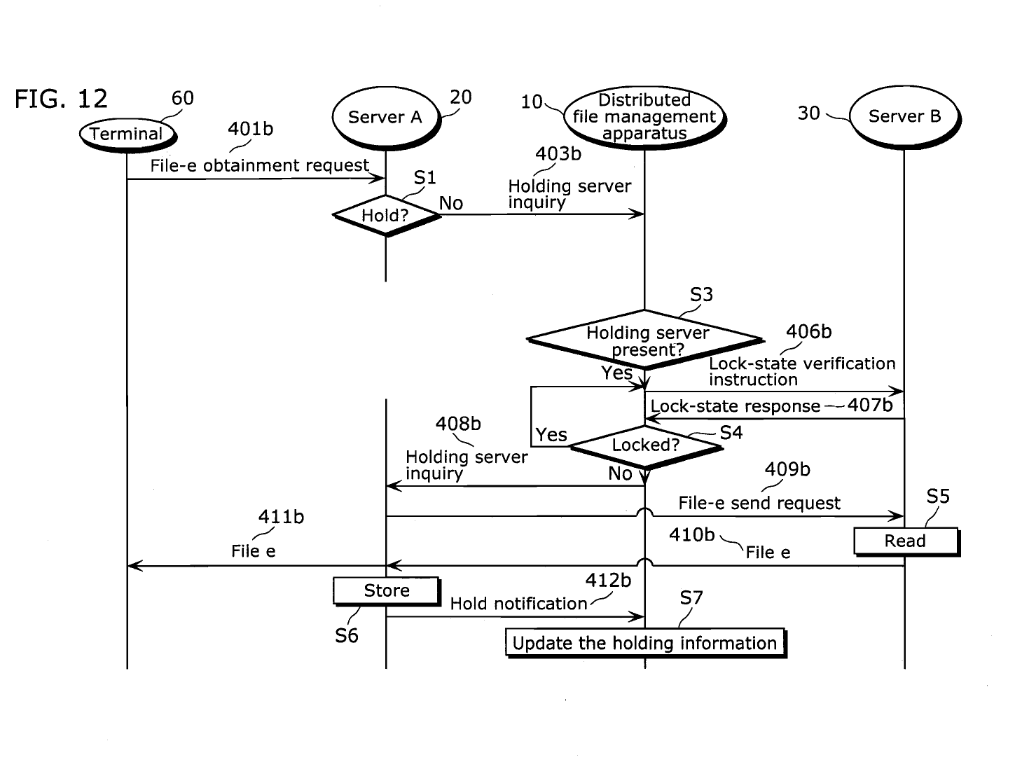

FIG. 12 is a time chart of a case where the user using the terminal a60 sends the server A a request to obtain a file e.

First, a file-e obtainment request 401b is sent from the terminal a60 to the server A20. The file-e obtainment request 401b is a signal whose description represents a request to obtain the file e.

Next, the request receiving unit 71 included in the server A20 receives the file-e obtainment request 401b. Receiving the file-e obtainment request 401b, the request receiving unit 71 sends the file-e obtainment request 401b and the address of the terminal a60 to the access destination determining unit 73.

The access destination determining unit 73 judges that the request obtained from the request receiving unit 71 is the file-e obtainment request 401b from the terminal a60, and judges whether or not its own file storage unit 25 holds the file e (S1).

Here, as shown in FIG. 3, the file storage unit 25a does not hold the file e. Thus, the access destination determining unit 73 judges that its own file storage unit 25 does not hold the file e (No in S1).

In response to the instruction from the access destination determining unit 73, the access destination inquiring unit 79 sends a holding server inquiry 403b to the distributed file management apparatus 10. The holding server inquiry 403b is a signal whose description represents an inquiry about a server that holds the file e.

Receiving the holding server inquiry 403b, the inquiry receiving unit 102 sends the holding server inquiry 403b to the holding server determining unit 104.

After obtaining the information specifying the server A20 and the holding server inquiry 403b from the inquiry receiving unit 102, the holding server determining unit 104 judges whether or not such a holding server is present by reference to the holding server information 100b stored in the holding server storage unit 100 (S3).

Here, as can be seen from the holding server information 100b shown in FIG. 8, the server B30 is the holding server of the file e. Thus, the holding server determining unit 104 judges that the holding server is present (Yes in S3).

Moreover, the holding server determining unit 104 reads the IP address of the server B30, which is the holding server, by reference to the management server information 100a, and then sends the read IP address to the control instruction sending unit 112.

The control instruction sending unit 112 sends a lock-state verification instruction 406b to the server B30. The lock-state verification instruction 406b is a signal used for verifying that the file storage unit 35 included in the servers B30 is locked.

The file storage control unit 77 receives the lock-state verification instruction 406, and sends a lock-state response 407b. The lock-state response 407b is a signal whose description represents whether or not the file storage unit 35 included in the server 30 that received the lock-state verification instruction 406b is locked.

The control instruction sending unit 112 receives the lock-state response 407b and judges, from the details of the lock-state response 407b, whether or not the file storage unit 35 included in the holding server 30 is locked (S4). When judging that it is locked (Yes in S4), the control instruction sending unit 112 sends the lock-state verification instruction 406 once again.

When judging that it is not locked (No in S4), the control instruction sending unit 112 notifies the holding server determining unit 104 that the file storage unit 35 is not locked.

Receiving this notification, the holding server determining unit 104 sends the access destination responding unit 106: the IP address of the server A; the IP address of the server B; and the holding server inquiry 403b.

In response to the instruction from the holding server determining unit 104, the access destination responding unit 106 sends a holding server notification 408b to the server B. The holding server notification 408b is a signal whose content is the holding server inquiry 403b and the IP address of the server B.

The access destination receiving unit 81 receives the holding server notification 408b, and then sends the received holding server notification 408b to the access destination determining unit 73. The access destination determining unit 73 judges, from the holding server notification 408b, that the server B30 is the access destination related to the file-e obtainment request 401b.

The access destination determining unit 73 sends a file-b send request 409b to the server B30. The file-b send request 409b is a signal whose description represents a request to send the file e to the server A20.

The request receiving unit 71 of the server B30 receives the file-e send request 409b. From the request receiving unit 71, the access destination determining unit 73 of the server B30 obtains the file-e send request 409 and the IP address of the server A20, which is the sender of the file-e send request 409b.

The access destination determining unit 73 of the server B30 judges that its own file storage unit 35 is the access destination since the request received by its own request receiving unit 71 is the file-e send request 409b sent from the server A20.

In response to the instruction from its own access destination determining unit 73, the file storage control unit 77 of the server B30 reads the file e from the electronic file information 35a (S5).

Obtaining the file e from its own file storage control unit 77, the access destination determining unit 73 of the server B30 sends the result sending unit 91: the obtained file e; the file-e send request 409b; and the address specifying the server A20 which is the sender of the file send request 409.

After obtaining the file e, the file-e send request 409b, and the address specifying the server A20 from its own access destination determining unit 73, the result sending unit 91 of the server B30 sends the file-e send request 409b and a file-e 410b to the server A20.

The result obtaining unit 85 sends the completion judging unit 87 the file-e send request 409b and the file-e 410b obtained as a result of the inquiry made to the distributed file management apparatus 10.

The completion judging unit 87 obtains the details of the file-e obtainment request 401b and the address specifying the terminal a60 which is the sender of the file-e obtainment request 401b, from the access destination determining unit 73.

Obtaining the file-e 410 in response to the file-e obtainment request 401b, the completion judging unit 87 first sends the address specifying the terminal a60 and the file-e 410b to the result sending unit 91.

In response to the instruction from the completion judging unit 87, the result sending unit 91 sends a file-e 411b to the terminal a60.

Moreover, obtaining the file-e 410b in response to the file-e obtainment request 401b, the completion judging unit 87 next sends the file-e 410b to the file storage control unit 77.

In response to the instruction from the completion judging unit 87, the file storage control unit 77 stores the file-e 410b in the electronic file information 25a (S6).

After storing the file-e 410b, the file storage control unit 77 notifies the completion judging unit 87 that the store processing of the file-e 410b is finished. The completion judging unit 87 judges that the processing related to the file obtainment request 401 is completed, and then notifies the completion notifying unit 89 that the file-e 410b is stored in the file storage unit 25.

Receiving the notification that the file-e 410b is held in the file storage unit 25, the completion notifying unit 89 sends a hold notification 412b to the distributed file management apparatus 10 and then terminates the processing.

The hold notification 412b is a signal whose description represents that the server A20 holds the file-e 410b.

Upon receiving the hold notification 412b, the notification receiving unit 108 sends the hold notification 412b to the holding information updating unit 110.

In accordance with the obtained hold notification 412b, the holding information updating unit 110 updates the holding server information 100b (S7), and then terminates the processing. To be more specific, the processing of updating the holding server information 100b in this case here is processing of adding the “Server A” to the “Server name” whose “File path” is “/data/c/e”.

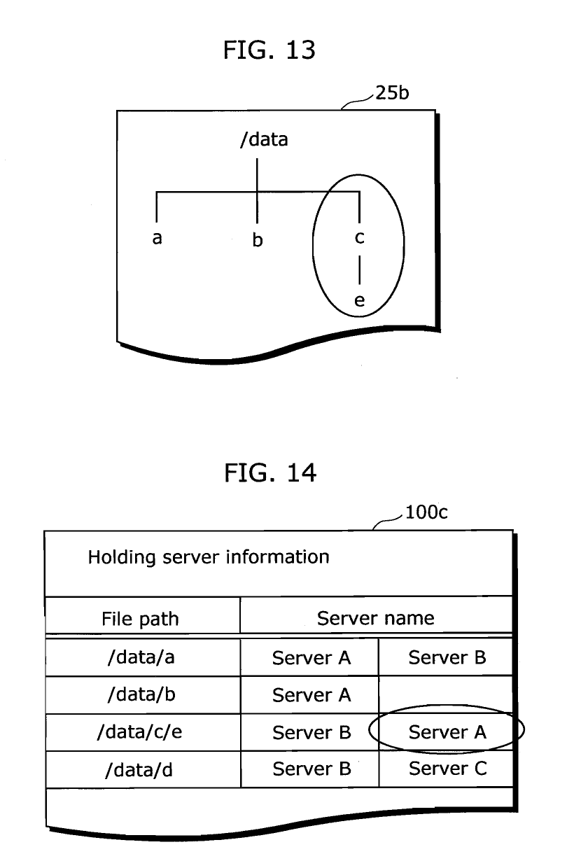

FIG. 13 is a diagram showing the electronic file information 25b stored in the file storage unit 25 of in the server A20 after the execution of the processing performed when the user using the terminal a60 sends the server A20 the request to obtain the file-e.

In S6, the file e is newly stored in the electronic file information 25b. As a result, “/c/e” is added under “/data” in the electronic file information 25b after the processing related to the file-e obtainment request 401b is completed.

Accordingly, when the server A20 receives a request to obtain the file e from the terminal again, the request can be speedily processed.

FIG. 14 is a diagram showing the holding server information 100c stored in the holding server storage unit 100 after the execution of the processing performed when the user using the terminal a60 sends the server A the request to obtain the file e.

Since the file e is stored in the electronic file information 25b, the holding server information 100c is updated in S7. As a result, the “Server A” is added as the holding server of “/data/c/e”.

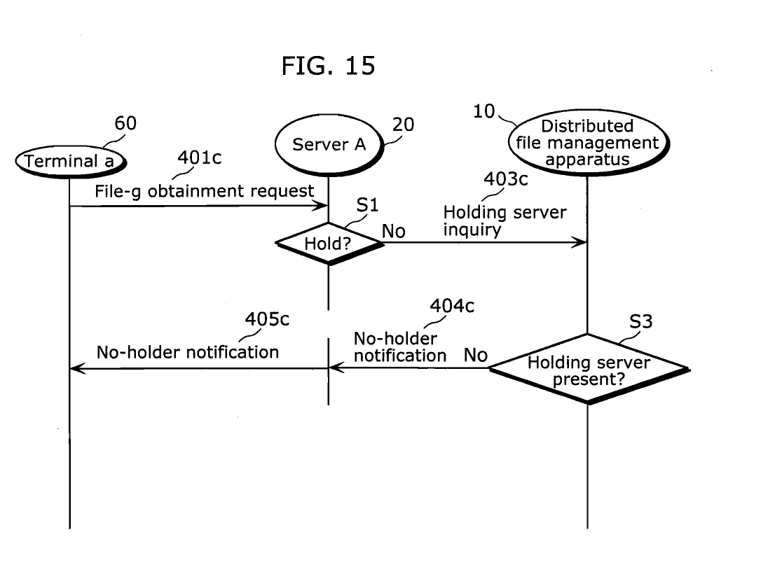

FIG. 15 is a time chart of a case where the user using the terminal a60 sends the server A20 a request to obtain a file g. First, a file-g obtainment request 401c is sent from the terminal a60 to the server A20. The file-g obtainment request 401c is a signal whose description represents a request to obtain the file g.

Next, the request receiving unit 71 of the server A20 receives the file-g obtainment request 401c. The request receiving unit 71 sends the file-g obtainment request 401c and the address of the terminal a60 to the access destination determining unit 73.

The access destination determining unit 73 judges that the request obtained from the request receiving unit 71 is the file-g obtainment request 401c from the terminal a60, and judges whether or not its own file storage unit 25 holds the file g (S1).

Here, as shown in FIG. 3, the file storage information 25a does not hold the file g. Thus, the access destination determining unit 73 judges that its own file storage unit 25 does not hold the file g (No in S1).

In response to the instruction from the access destination determining unit 73, the access destination inquiring unit 79 sends a holding server inquiry 403c to the distributed file management apparatus 10. The holding server inquiry 403c is a signal whose description represents an inquiry about a server that holds the file g.

Upon receiving the holding server inquiry 403c, the inquiry receiving unit 102 sends the holding server inquiry 403c to the holding server determining unit 104.

After obtaining the information specifying the server A20 and the holding server inquiry 403c from the inquiry receiving unit 102, the holding server determining unit 104 judges whether or not such a holding server is present by reference to the holding server information 100b stored in the holding server storage unit 100 (S3).

Here, as can be seen from the holding server information 100b shown in FIG. 8, a holding server of the file g is not present. Thus, the holding server determining unit 104 judges that the holding server is not present (No in S3).

In response to the judgment made by the holding server determining unit 104, the access destination responding unit 106 sends a no-holder notification 404c to the server A20. The no-holder notification 404c is a signal whose description represents that no such holding server is present.

The access destination receiving unit 81 obtains the no-holder notification 404c as a result of the inquiry made to the distributed file management apparatus 10, and then sends the no-holder notification 404c to the access destination determining unit 73. Obtaining the no-holder notification 404c, the access destination determining unit 73 judges that the processing related to the file obtainment request 401c is completed since the no-holder notification 404c is obtained. Then, the access destination determining unit 73 sends the result sending unit 91: the address specifying the terminal a60 which is the sender of the file obtainment request 401c; and the no-holder notification 404c.

In response to the instruction from the access destination determining unit 73, the result sending unit 91 sends a no-holder notification 405c to the address of the terminal a60, and then terminates the processing. The no-holder notification 405c is a signal whose description represents that no holding server is present.

As described so far, even when the user sends a request to obtain an electronic file which is not stored in the servers that are, like the access source server, the management objects of the distributed file management apparatus 10, the access source server can judge, only by accessing the distributed file management apparatus 10, that no server is present that holds the requested file. On account of this, the access source server does not need to access all the servers in such a case for example, thereby reducing the time taken for the processing.

Moreover, the user can find out that the desired file is not stored in the servers which are, like the access source server, the management objects of the distributed file management apparatus 10.

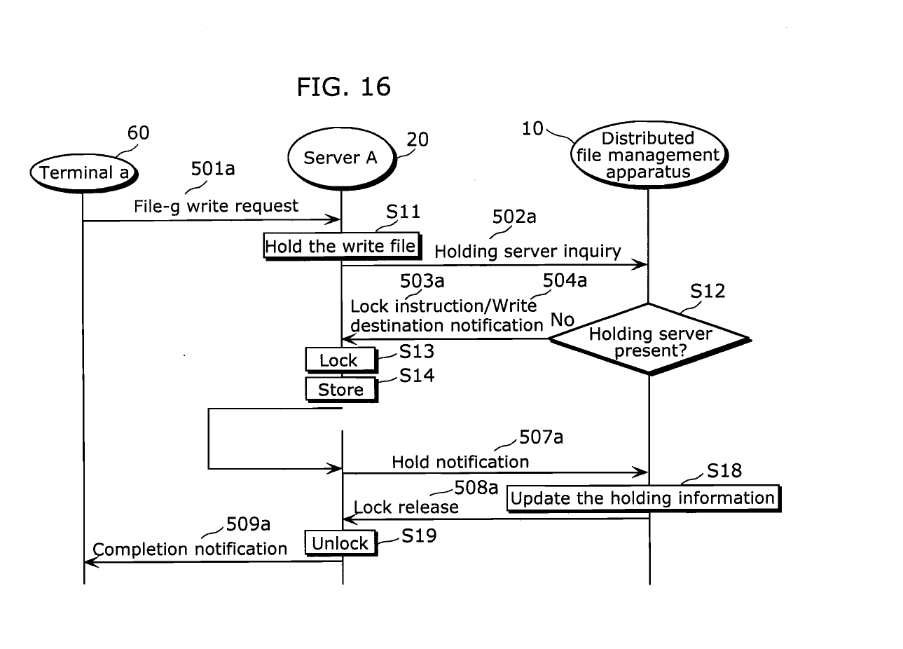

FIG. 16 is a time chart of a case where the user using the terminal a60 sends the server A20 a request to write the file g

First, a file-g write request 501a is sent to the server A20 from the terminal a60.

The file-g write request 501a is a signal whose description represents a request to write the file g.

Next, upon receiving the file-g write request 501a, the request receiving unit 71 sends the file-g write request 501a and information specifying the sender of the request 501a, such as the address of the terminal a60, to the access destination determining unit 73.

The address destination determining unit 73 judges that the request received from the request receiving unit 71 is the file-g write request 501a sent from the terminal a60, and stores the file g in the write file holding unit 75 (S11).

The address destination determining unit 73 next sends the file-g write request 501a to the access destination inquiring unit 75.

The access destination inquiring unit 75 sends a holding server inquiry 502a to the distributed file management apparatus 10. The holding server inquiry 502a is a signal whose description represents an inquiry about a server that holds the file g.

Receiving the holding server inquiry 502a, the inquiry receiving unit 102 sends the holding server inquiry 502a to the holding server determining unit 104. The holding server determining unit 104 judges whether or not such a holding server is present, by reference to the holding server information 100b stored in the holding server storage unit 100 (S12).

Here, as can be seen from the holding server information 100b shown in FIG. 8, such a holding server is not present. Thus, the holding server determining unit 104 judges that the holding server is not present (No in S12).

In response to the judgment made by the holding server determining unit 104, the control instruction sending unit 112 first sends a lock instruction 503a to the server A20. The lock instruction 503a is a signal whose description represents an instruction to lock the file storage unit 25 so that the file storage unit 25 (or, 35 or 45) receives a write instruction only from the subsequently-connected distributed file management apparatus 10.

Upon receiving the lock instruction 503a, the file storage control unit 77 locks the file storage unit 25 (S13).

Following the transmission of the lock instruction 503a by the control instruction sending unit 112, the access destination responding unit 106 sends a write destination notification 504a to the server A20. Since there is no server that holds the file g, the write destination notification 504a is a signal whose description represents that its own file storage unit 25 is the only storage destination of the file g.

Upon receiving the write destination notification 504a, the access destination receiving unit 81 sends the write destination notification 504a to the access destination determining unit 73. From the write destination notification 504a, the access destination determining unit 73 judges that the access destination related to the file write request 501a is only its own file storage unit 25.

The access destination determining unit 73 outputs a write instruction based on the write destination notification 504a to its own file storage control unit 77. The file storage control unit 77 obtains the file g from the write file holding unit 75, and stores the obtained file g in the file storage unit 25 (S14).

Upon completion of the writing according to the write destination notification 504a, the file storage control unit 77 notifies the completion judging unit 87 that the writing according to the write destination notification 504a is finished.

The completion judging unit 87 judges that the processing related to the file write request 501a is completed. Judging that the processing related to the file write request 501a is completed, the completion judging unit 87 notifies the completion notifying unit 89 that the file g is stored in the file storage unit 25.

The completion notifying unit 89 sends a hold notification 507a to the distributed file management apparatus 10. The hold notification 507 is a signal whose description represents that the file g is stored.

Upon receiving the hold notification 507a, the notification receiving unit 108 sends the hold notification 507a to the holding information updating unit 110. In accordance with the obtained hold notification 507a, the holding information updating unit 110 updates the holding server information 100b.

To be more specific, the processing of updating the holding server information 100b in this case here is processing of adding “/data/g” to the “File path” and also adding the “Server A” to the corresponding “Server name”.

Upon completion of the update processing, the holding information updating unit 110 notifies the control instruction sending unit 112 that the update processing related to the file write request 501a is finished. Then, the control instruction sending unit 112 sends a lock release 508a to the access source server, that is, the server A20. The lock release 508a is a signal whose description represents that the lock executed following the lock instruction 503a is released.

Upon receiving the lock release 508a, the file storage control unit 77 unlocks the file storage unit 25 (S19). The file storage control unit 77 notifies the completion judging unit 87 that the lock is released.

The completion judging unit 87 judges that the write processing related to the file-g write request 501a is completed and notifies the result sending unit 91 of this.

The result sending unit 91 sends a completion notification 509a to the terminal a60 which is the sender of the file-g write request 501a, and then terminates the processing. The completion notification 509a is a signal whose description represents that the processing related to the file-g write request 501a is completed.

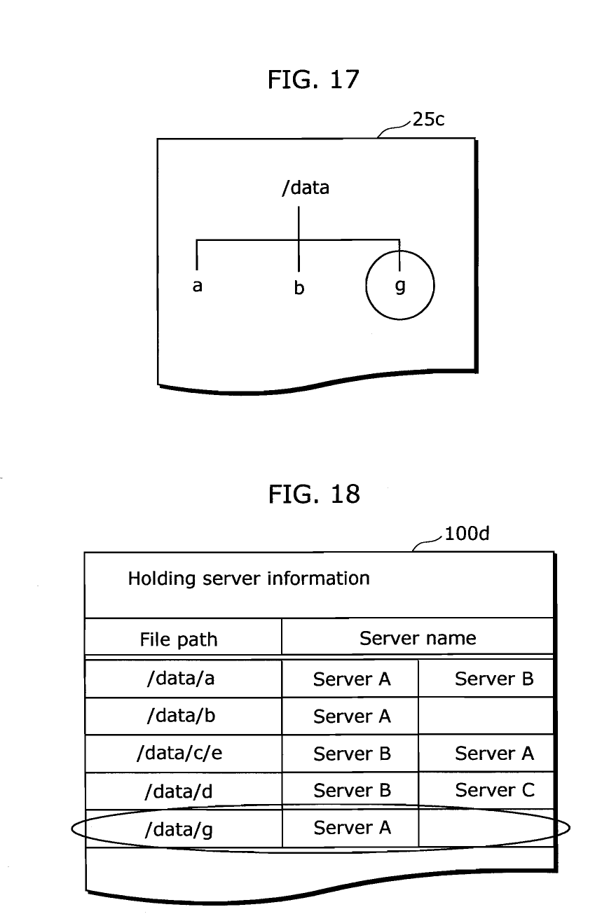

FIG. 17 is a diagram showing the electronic file information 25c stored in the file storage unit 25 included in the server A20 after the execution of the processing performed when the user using the terminal a60 sends the server A the request to write the file g.

In S14, the file g is newly stored in the electronic file information 25a. As a result, “/g” is added under “/data” in the electronic file information 25c after the processing related to the file-g write request 501a is completed.

FIG. 18 is a diagram showing the holding server information 100d stored in the holding server storage unit 100 after the execution of the processing performed when the user using the terminal a60 sends the server A20 the request to write the file g.

Since the file g is stored in the electronic file information 25c, the holding server information 100b is updated in S18. As a result, “/data/g” is added to the “File path” of the holding server information 100d, and also the “Server A” is added to the corresponding Server name.

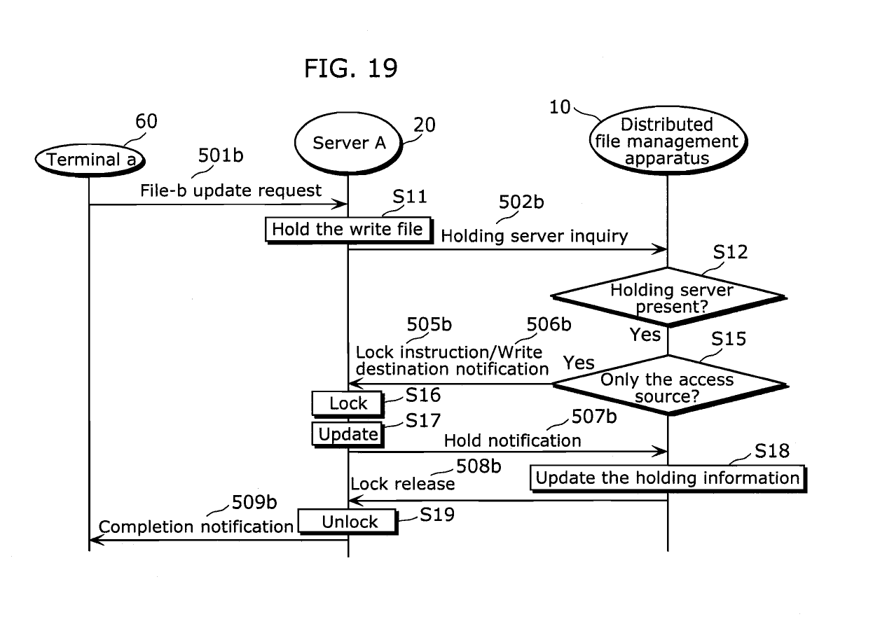

FIG. 19 is a time chart of a case where the user using the terminal a60 sends the server A20 a request to update a file b.

First, a file-b update request 501b is sent from the terminal a60 to the server A20. The file-b update request 501b is a signal whose description represents a request to write a file b_2.

Next, upon receiving the file-b update request 501, the request receiving unit 71 of the server A20 sends the file-b update request 501b and the address of the terminal a60 which is the sender of the file-b update request 501b to the access destination determining unit 73.

Obtaining the file-b update request 501b and the address of the terminal a60, the access destination determining unit 73 judges that the request obtained from the request receiving unit 71 is the file-b update request 501b from the terminal a60, and stores the file b_2 in the write file holding unit 75 (S11).

Obtaining the file-b update request 501b and the address of the terminal a60, the access destination determining unit 73 next sends the file-b update request 501b to the access destination inquiring unit 75.

The access destination inquiring unit 75 sends a holding server inquiry 502b to the distributed file management apparatus 10. The holding server inquiry 502b is a signal whose description represents an inquiry about a server that holds the file b.

Upon receiving the holding server inquiry 502b, the inquiry receiving unit 102 sends the holding server inquiry 502b to the holding server determining unit 104.

After obtaining the information specifying the server A20 and the holding server inquiry 403 from the inquiry receiving unit 102, the holding server determining unit 104 judges whether or not such a holding server is present by reference to the holding server information 100b stored in the holding server storage unit 100 (S12).

Here, as can be seen from the holding server information 100b shown in FIG. 8, the server A holds the file b. Thus, the holding server determining unit 104 judges that the holding server is present (Yes in S12).

Following this, the holding server determining unit 104 judges whether or not the server A20 is only one holding server (S15).

Here, as can be seen from the holding server information 100b shown in FIG. 8, the server A20 is only one holding server. Thus, the holding server determining unit 104 judges that the server A20 is only one holding server (Yes in S15).

In response to the judgment made by the holding server determining unit 104, the control instruction sending unit 112 first sends a lock instruction 505b to the server A20. The lock instruction 505b is a signal whose description represents an instruction to lock the file storage unit 25 so that the file storage unit 25 (or, 35 or 45) receives a write instruction only from the subsequently-connected distributed file management apparatus 10.

Receiving the lock instruction 505b, the file storage control unit 77 performs the same processing as described in S13, and locks the file storage unit 25 in accordance with the lock instruction 505b (S16).

Following this, the access destination responding unit 106 sends a write destination notification 506b to the server A20. Since only the server A20 holds the file b, the write destination notification 506b is a signal whose description represents that a storage destination of the file b_2 is only its own file storage unit 25.

Upon receiving the write destination notification 506b, the access destination receiving unit 81 sends the write destination notification 506b to the access destination determining unit 73.

From the write destination notification 506b, the access destination determining unit 73 judges that the access destination related to the file-b update request 501b is only its own file storage unit 25. Then, the access destination determining unit 73 outputs a write instruction based on the write destination notification 506 to its own file storage control unit 77.

Obtaining the write instruction based on the write destination notification 506b, the file storage control unit 77 obtains the file b_2 from the write file holding unit 75, and updates the file storage unit 25 (S17).

The updating in this case here refers to processing of, for example, overwriting the information except the file name “file b” out of the information included in the file b, that is, overwriting the entity of the file b and the data and time of creation of the file b that have been held by the file storage unit 25, with the file b_2.

Upon completion of the writing according to the write destination notification 506b, the file storage control unit 77 notifies the completion judging unit 87 of this completion of the writing.

The completion judging unit 87 judges that the processing related to the file update request 501 is completed, and notifies the completion notifying unit 89 that the file b is updated with the file b_2 in the file storage unit 25 of the server A20.

Receiving this notification, the completion notifying unit 89 sends a hold notification 507b to the distributed file management apparatus 10. The hold notification 507b is a signal whose description represents that the file b is updated with the file b_2.

Upon receiving the hold notification 507b, the notification receiving unit 108 sends the hold notification 507b to the holding information updating unit 110. Then, the holding information updating unit 110 updates the holding server information 100b in accordance with the obtained hold notification 507b (S18).

The processing of updating the holding server information 100b in this case here is processing of updating the attribute information of the file b to the attribute information of the file b_2.

Upon completion of the update processing (S18), the holding information updating unit 110 notifies the control instruction sending unit 112 that the update processing related to the file-b update request 501b is finished.

Obtaining the notification that the update processing related to the file-b update request 501b is finished, the control instruction sending unit 112 sends a lock release 508b to the access server, that is, the server A20. The lock release 508b is a signal whose description represents that the lock executed following the lock instruction 505b related to the file-b update request 501b is released.

Upon receiving the lock release 508b, the file storage control unit 77 unlocks the file storage unit 25 (S19).

Obtaining the notification that the lock related to the file-b update request 501b is released, the completion judging unit 87 judges that the write processing related to the file-b update request 501b is finished and notifies the result sending unit 91 of this.

The result sending unit 91 sends a completion notification 509b to the terminal a60 which is the sender of the file-b update request 501b, and then terminates the processing. The completion notification 509b is a signal whose description represents that the processing related to the file-b update request 501b is completed.

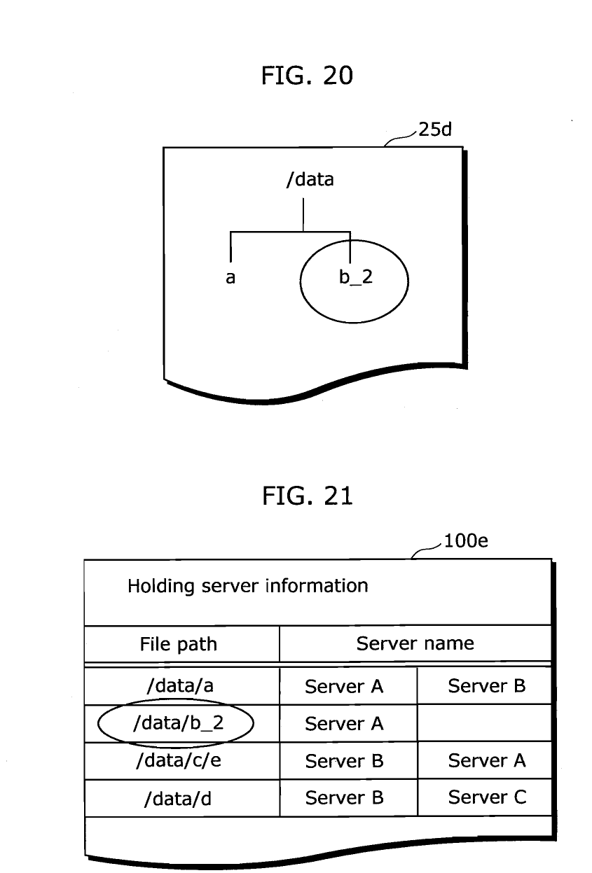

FIG. 20 is a diagram showing the electronic file information 25d stored in the file storage unit 25 included in the server A20 after the execution of the processing performed when the user using the terminal a60 sends the server A20 the request to update the file b.

The file b of the electronic file information 25a is updated in S17. Thus, after the processing related to the file-b update request 501b is finished, “/data/b” of the electronic file information 25d is updated to “/data/b_2”.

FIG. 21 is a diagram showing the holding server information 100e stored in the holding server storage unit 100 after the execution of the processing performed when the user using the terminal a sends the server A20 the request to update the file b.

Since the file b of the electronic file information 25a is updated, the holding server information 100b is updated in S18. Thus, “/data/b” of the “File path” is updated to “/data/b_2”.

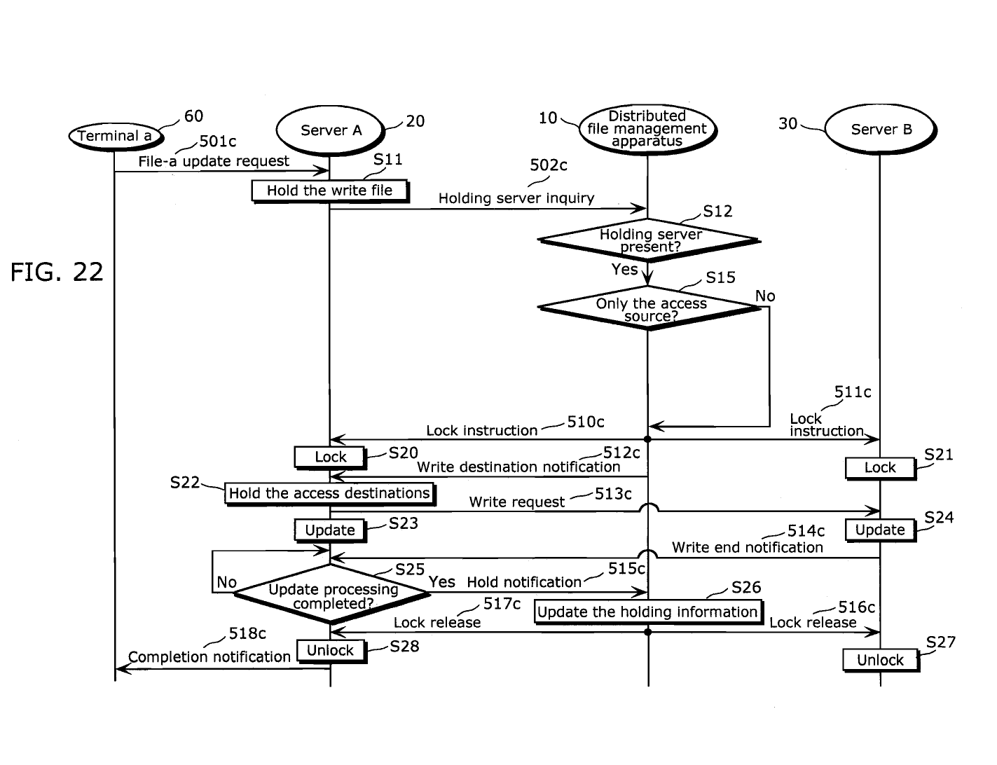

FIG. 22 is a time chart of a case where the user using the terminal a60 sends the server A20 a request to update the file a.

First, a file-a update request 501c is sent from the terminal a60 to the server A20. The file-a update request 501b is a signal whose description represents a request to write a file a_2.

Next, upon receiving the file-a update request 501c, the request receiving unit 71 of the server A20 sends the file-a update request 501c and the address of the terminal a60 to the access destination determining unit 73.

Obtaining the file-a update request 501c and the address of the sender of the file-a update request 501c, the access destination determining unit 73 judges that the request obtained from the request receiving unit 71 is the file-a update request 501c from the terminal a60, and stores the file a in the write file holding unit 75 (S11).

Next, the access destination determining unit 73 sends the file-a write request 501c to the access destination inquiring unit 75, and sends a holding server inquiry 502c to the distributed file management apparatus 10. The holding server inquiry 502c is a signal whose description represents an inquiry about a server that holds the file a.

Upon receiving the holding server inquiry 502c, the inquiry receiving unit 102 sends the holding server inquiry 502c to the holding server determining unit 104.

After obtaining the information specifying the server A20 and the holding server inquiry 403c from the inquiry receiving unit 102, the holding server determining unit 104 judges whether or not such a holding server is present by reference to the holding server information 100b stored in the holding server storage unit 100 (S12).

Here, as can be seen from the holding server information 100b shown in FIG. 8, the server A and the server B30 hold the file a. Thus, the holding server determining unit 104 judges that the holding server is present (Yes in S12).

Following this, the holding server determining unit 104 judges whether or not the server A20 is only one holding server (S15).

As mentioned above, the server A and the server B are the holding servers. Thus, the holding server determining unit 104 judges that the server A20 is not only one holding server (Yes in S15), and obtains the IP addresses of the holding servers by reference to the management server information 100a stored in the holding server storage unit 100.

From the holding server determining unit 104, the control instruction sending unit 112 receives: the IP address of the server A20, which is the sender of the file-a write request 501c; the IP address of the server B30, which is the holding server; and an instruction to send a lock instruction 510c and a lock instruction 511c. Then, the control instruction sending unit 112 sends these instructions to the server A20 and the server B30 respectively.

The lock instruction 510 and the instruction 511 are signals whose respective descriptions represent instructions to lock the file storage unit 25 and the file storage unit 35 so as to each receive a write instruction only from the subsequently-connected distributed file management apparatus 10.

Receiving the lock instruction 510, the file storage control unit 77 of the server A20 and the file storage control unit 77 of the server B30 respectively lock the file storage unit 25 and the file storage unit 35 in accordance with the lock instructions (S20 and S21).

Following this, from the holding server determining unit 104, the access destination responding unit 106 receives a signal whose content is: the IP address of the server B30; the IP address of the server A20; and a description representing that this is a response to the file-a write request 501c. The access destination responding unit 106 sends a write destination notification 512c to the server A20.

The write destination notification 512c is a signal whose content is: the IP address of the server B30, which is the holding server; and a description representing that this is a response to the file-a write request 501c.

Receiving the write destination notification 512c, the access destination receiving unit 81 sends the received write destination notification 512c to the access destination determining unit 73.

From the obtained write destination notification 512c, the access destination determining unit 73 judges that the server B30 and its own file storage unit 25 are the access destinations. Thus, the access destination determining unit 73 notifies the completion judging unit 87 of the access destinations related to this judgment.

The completion judging unit 87 temporarily holds the access destinations related to this judgment (S22).

Meanwhile, the access destination determining unit 73 outputs an instruction to update the file a and the file a to its own file storage control unit 77. In accordance with this instruction, the file storage control unit 77 updates the file a with the file a_2 (S23).

Upon completion of the update processing (S23), the file storage control unit 77 notifies the completion judging unit 87 that the processing performed for the file storage unit 25, which is one of the access destinations, is finished.

On the other hand, the access destination determining unit 73 sends the IP address of the server B30 to the processing requesting unit 83. The processing request 83 obtains the file a_2 from the write file holding unit 75 and sends a write request 513c to the server B30.

The write request 513c is a signal whose content is the file a_2 and an instruction to store the present file.

Upon receiving the write request 513c, the request receiving unit 71 of the server B30 sends the information specifying the server A20 to the access destination determining unit 73.

The access destination determining unit 73 of the server B30 judges that its own file storage unit 35 is the access destination because the sender of the write request 513c is the other server. Thus, the access destination determining unit 73 outputs the file a_2 and an instruction to update the current file to the file storage control unit 77.

Upon receiving the update instruction, the file storage control unit 77 of the server B30 updates the electronic file information 35a using the file a_2, in accordance with the received instruction (S24).

Following this, the access destination determining unit 73 of the server B30 is notified by the file storage control unit 77 that the update processing (S24) is completed, and thus outputs this notification to the result sending unit 91. The result sending unit 91 sends the server A20 a write end notification 514c as a result.

The write end notification 514c is a signal whose description represents that the processing related to the file-a write request 513c is completed in the server B30.

The result obtaining unit 85 of the server A20 obtains the write end notification 514c, and sends the obtained write end notification 514c to the completion judging unit 87.

The completion judging unit 87 judges whether or not the write processing related to the file-a write request 513c is completed (S25). To do so, the completion judging unit 87 judges whether or not the end notification has been received from each of the server A20 and the server B30. Because the write end notification is received from the file storage control unit 77 of the server A20 after the update processing (S23) and the write end notification 514c is received from the server B30, the completion judging unit 87 judges that the write processing related to the file-a write request 513c is completed (Yes in S25).

Following this, the completion judging unit 87 instructs the completion notifying unit 89 to send a hold notification 515c.

The hold notification 515c is a signal whose description represents that the file storage unit 25 and the file storage unit 35 are updated using the file a_2.

Receiving the hold notification 515c, the notification receiving unit 108 sends this hold notification 515c to the holding information updating unit 110. In accordance with the description of the hold notification 515c, the holding information updating unit 110 updates the holding server information 100b (S26). In this case here, as the updated details, the file a is updated with the file a_2.

After updating the holding server information 100b, the holding information updating unit 110 notifies the control instruction sending unit 112 that the update of the holding server information 100b is completed. Then, the control instruction sending unit 112 sends lock releases 516c and 517c to the server A20 and the server B30, and terminates the processing.

The file storage control unit 77 of the server A20 and the file storage control unit 77 of the server B30 receive the lock releases 516c and 517c, and then respectively unlock the file storage unit 25 and the file storage unit 35 (S27 and S28).

After the lock release (S28), the file storage control unit 77 of the server A20 outputs the lock release to the completion judging unit 87. The completion judging unit 87 notifies the result sending unit 91, as a result, that the processing related to the file-a write request 501c is completed.

In accordance with the result received from the completion judging unit 87, the result sending unit 91 sends a completion notification 518c to the terminal a60, and then terminates the processing. The completion notification 518c is a notification whose description represents that the write processing related to the file-a write request 501c is completed.

The terminal a60 receives the completion notification 518, and then terminates the processing.

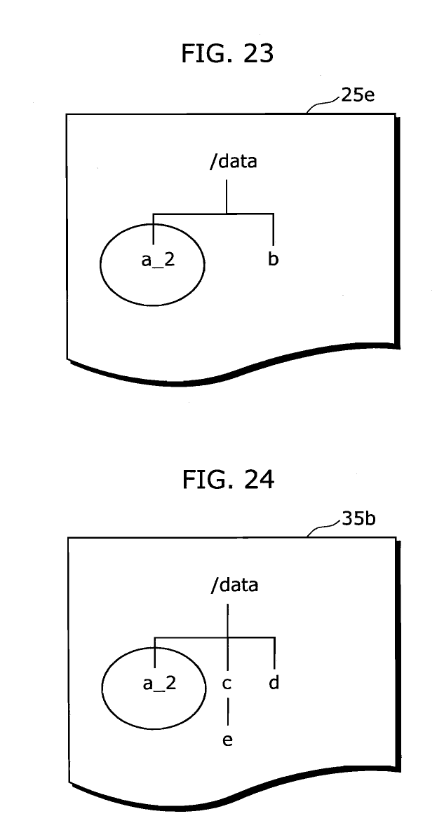

FIG. 23 is a diagram showing the electronic file information stored in the file storage unit 25 included in the server A20 after the execution of the processing performed when the user using the terminal a60 sends the server A20 the request to update the file a.

The file a of the electronic file information 25a is updated in S23. Thus, after the processing related to the file-a write request 501c is completed, “/data/a” of the electronic file information 25e is updated to “/data/a_2”.

FIG. 24 is a diagram showing the electronic file information stored in the file storage unit 35 included in the server B30 after the execution of the processing performed when the user using the terminal a60 sends the server A20 the request to update the file a.

The file a of the electronic file information 35a is updated in S24. Thus, after the processing related to the file-a write request 501c is completed, “/data/a” of the electronic file information 35b is updated to “/data/a_2”.

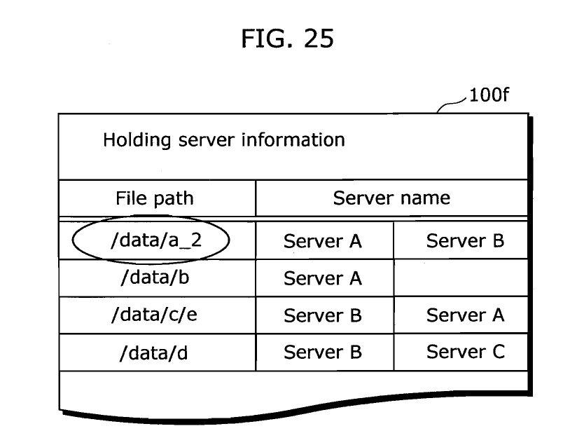

FIG. 25 is a diagram showing the holding server information stored in the holding server storage unit 100 after the execution of the processing performed when the user using the terminal a60 sends the server A20 the request to update the file a.

Since the file a in each of the file storage unit 25 and the file storage unit 35 is updated with the file a_2, the holding server information 100b is updated in S26. Thus, “/data/a” of the “File path” is updated to “/data/a_2” in the holding server information 100f.

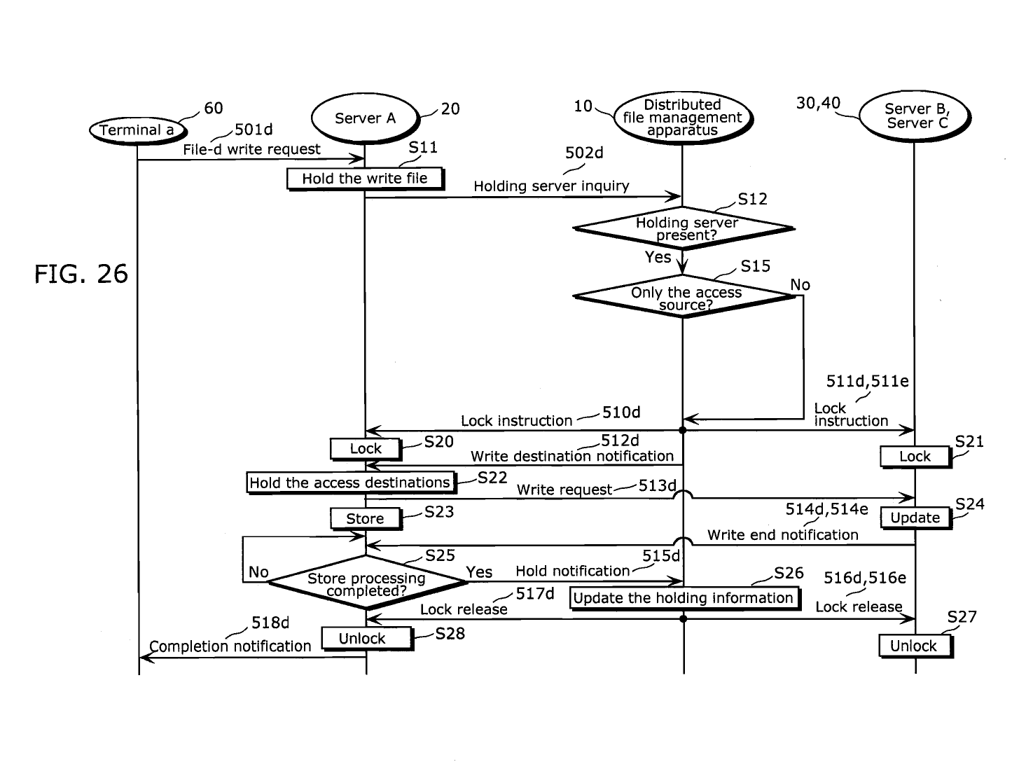

FIG. 26 is a time chart of a case where the user using the terminal a60 sends the server A20 a request to update a file d.

First, a file-d write request 501d is sent from the terminal a60 to the server A20. The file-d write request 501d is a signal whose description represents a request to write a file d_2.

Next, upon receiving the file-d write request 501d, the request receiving unit 71 of the server A20 sends the file-d write request 501d and the address of the terminal a60 to the access destination determining unit 73.

Obtaining the file-d write request 501d and the address of the sender of the file-d write request 501d, the access destination determining unit 73 judges that the request obtained from the request receiving unit 71 is the file-d write request 501d from the terminal a60, and stores the file d_2 in the write file holding unit 75 (S11).

Next, the access destination determining unit 73 sends the file-d write request 501d to the access destination inquiring unit 75, and sends a holding server inquiry 502d to the distributed file management apparatus 10. The holding server inquiry 502d is a signal whose description represents an inquiry about a server that holds the file d.

Upon receiving the holding server inquiry 502d, the inquiry receiving unit 102 sends the holding server inquiry 502d to the holding server determining unit 104.

After obtaining the information specifying the server A20 and the holding server inquiry 502d from the inquiry receiving unit 102, the holding server determining unit 104 judges whether or not such a holding server is present by reference to the holding server information 100b stored in the holding server storage unit 100 (S12).

Here, as can be seen from the holding server information 100b shown in FIG. 8, the server B30 and the server C40 hold the file d. Thus, the holding server determining unit 104 judges that the holding server is present (Yes in S12).

Following this, the holding server determining unit 104 judges whether or not the server A20 is only one holding server (S15).

As mentioned above, the server B30 and the server C40 are the holding servers. Thus, the holding server determining unit 104 judges that the server A20 is not only one holding server (Yes in S15), and obtains the IP addresses of the holding servers by reference to the management server information 100a stored in the holding server storage unit 100.

From the holding server determining unit 104, the control instruction sending unit 112 receives: the IP address of the server A20, which is the sender of the file-d write request 501d; the IP address of the server B30, which is the holding server; the IP address of the server C40, which is the holding server; and an instruction to send a lock instruction 510d, a lock instruction 511d, and a lock instruction 511e. Then, the control instruction sending unit 112 sends these instructions to the server A20, the server B30, and the server C40 respectively.

The lock instruction 510d, the instruction 511d, and the lock instruction 511e are signals whose respective descriptions represent instructions to lock the file storage unit 25, the file storage unit 35, and the file storage unit 45 so as to each receive a write instruction only from the subsequently-connected distributed file management apparatus 10.

Receiving the lock instruction 510d, the file storage control unit 77 of the server A20 locks the file storage unit 25 in accordance with the lock instruction (S20). Similarly, the server B30 and the server C40 lock the file storage unit 35 and the file storage unit 45 respectively (S21).

Following this, from the holding server determining unit 104, the access destination responding unit 106 receives a signal whose content is: the IP addresses of the server A 20, the server B30, and the server C40; and a description representing that this is a response to the file-d write request 501d. The access destination responding unit 106 sends a write destination notification 512d to the server A20.

The write destination notification 512d is a signal whose content is: the IP addresses of the server B30 and the server C40, which are the holding servers; and a description representing that this is a response to the file-d write request 501d.

Receiving the write destination notification 512d, the access destination receiving unit 81 notifies the access destination determining unit 73 of the received write destination notification 512d.

From the obtained write destination notification 512d, the access destination determining unit 73 judges that the server B30, the server C40, and its own file storage unit 25 are the access destinations. Thus, the access destination determining unit 73 notifies the completion judging unit 87 of the access destinations related to this judgment.

The completion judging unit 87 temporarily holds the access destinations related to the judgment (S22).

Meanwhile, the access destination determining unit 73 outputs an instruction to update the file d and the file d to its own file storage control unit 77. In accordance with this instruction, the file storage control unit 77 newly stores the file d_2 (S23).

Upon completion of the store processing (S23), the file storage control unit 77 notifies the completion judging unit 87 that the processing performed for the file storage unit 25, which is one of the access destinations, is finished.

On the other hand, the access destination determining unit 73 sends the IP addresses of the server B30 and the server C40 to the processing requesting unit 83. The processing request 83 obtains the file d_2 from the write file holding unit 75 and sends a write request 513d to each of the server B30 and the server C.

The write request 513d is a signal whose content is the file d_2 and an instruction to store the present file.

Upon receiving the write request 513d, the request receiving unit 71 of the server B30 sends the information specifying the server A20 to the access destination determining unit 73.

The access destination determining unit 73 of the server B30 judges that its own file storage unit 35 is the access destination because the sender of the write request 513d is the other server. Thus, the access destination determining unit 73 outputs the file d_2 and an instruction to update the current file to the file storage control unit 77.

Upon receiving the update instruction, the file storage control unit 77 of the server B30 updates the electronic file information 35a using the file d_2, in accordance with the received instruction (S24). Following this, the access destination determining unit 73 is notified by the file storage control unit 77, which has finished the update processing (S24), that the update processing of the file d is completed. Then, the access destination determining unit 73 outputs this notification to the result sending unit 91. The result sending unit 91 sends the server A20 a write end notification 514d as a result.

The write end notification 514d is a signal whose description represents that the processing related to the file-d write request 513d is completed in the server B30.

The processing performed in the server B30 is similarly performed in the server C40. When the file d is updated, a write end notification 514e is sent to the server A20.

The write end notification 514e is a signal whose description represents that the processing related to the file-d write request 513d is completed in the server C40.

The result obtaining unit 85 of the server A20 obtains the write end notification 514c and the write end notification 514e, and sends these obtained write end notifications to the completion judging unit 87.

The completion judging unit 87 judges whether or not the write processing related to the file-d write request 513d is completed (S25). To do so, the completion judging unit 87 judges whether or not the end notification has been received from each of the server A20, the server B30, and the server C40. Because the write end notification is received from the file storage control unit 77 of the server A20 after the update processing (S23) and the write end notification 514d and the write end notification 514e are received from the server B30 and the server C40 respectively, the completion judging unit 87 judges that the write processing related to the file-d write request 513d is completed (Yes in S25).

Following this, the completion judging unit 87 instructs the completion notifying unit 89 to send a hold notification 515d.

The hold notification 515d is a signal whose description represents that the file storage unit 25, the file storage unit 35, and the file storage unit 45 are updated using the file d_2.

Receiving the hold notification 515d, the notification receiving unit 108 sends this hold notification 515d to the holding information updating unit 110. In accordance with the description of the hold notification 515d, the holding information updating unit 110 updates the holding server information 100b (S26). In this case here, as the updated details, the file d is updated with the file d_2.

After updating the holding server information 100b, the holding information updating unit 110 notifies the control instruction sending unit 112 that the update of the holding server information 100b is completed. Then, the control instruction sending unit 112 sends lock releases 516d, 516e, and 517d to the server A20, the server B30, and the server C40 respectively, and terminates the processing.

The file storage control unit 77 of the server A20, the file storage control unit 77 of the server B30, and the file storage control unit 77 of the server C40 respectively receive the lock releases 516d, 516e, and 517d, and then respectively unlock the file storage unit 25, the file storage unit 35, and the file storage unit 45 (S27 and S28).

After the lock release (S28), the file storage control unit 77 of the server A20 outputs the lock release to the completion judging unit 87. The completion judging unit 87 notifies the result sending unit 91, as a result, that the processing related to the file-d write request 501d is completed.

In accordance with the result received from the completion judging unit 87, the result sending unit 91 sends a completion notification 518d to the terminal a60, and then terminates the processing. The completion notification 518d is a notification whose description represents that the write processing related to the file-d write request 501d is completed.

The terminal a60 receives the completion notification 518, and then terminates the processing.

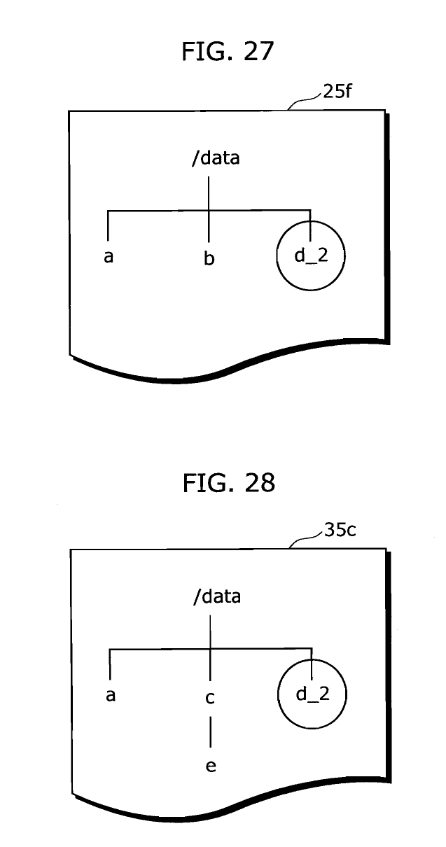

FIG. 27 is a diagram showing the electronic file information stored in the file storage unit 25 included in the server A20 after the execution of the processing performed when the user using the terminal a60 sends the server A the request to write the file d.

The file d_2 is newly stored in the electronic file information 25a in S23. Thus, after the processing related to the file-d write request 501d is completed, “/data/d_2” is added to the electronic file information 25f.

FIG. 28 is a diagram showing the holding server information stored in the file storage unit 35 included in the server B30 after the execution of the processing performed when the user using the terminal a60 sends the server A20 the request to write the file d.

The file d of the electronic file information 35a is updated in S24. Thus, after the processing related to the file-d write request 501d is completed, “/data/d” of the electronic file information 35c is updated to “/data/d_2”.

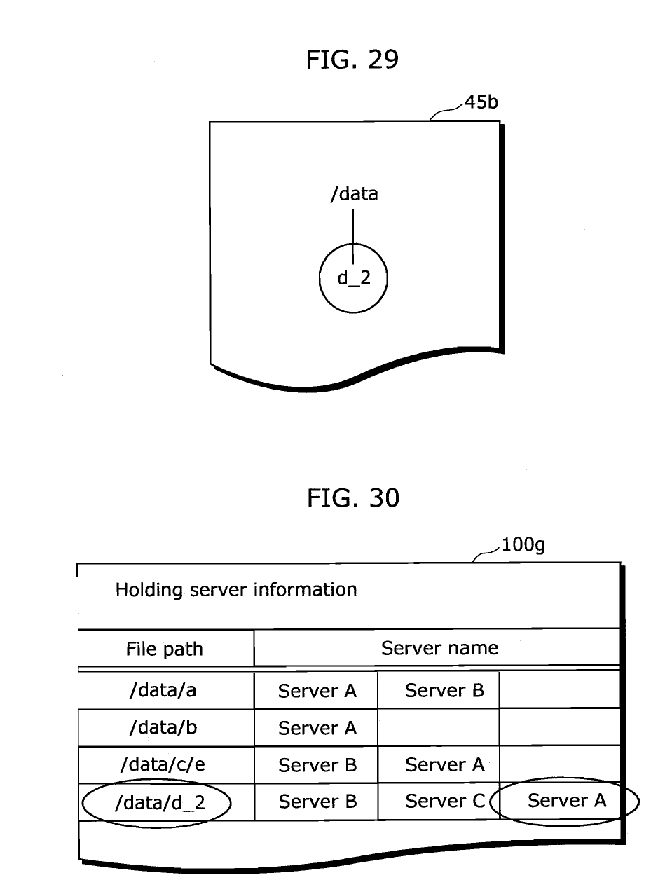

FIG. 29 is a diagram showing the electronic file information stored in the file storage unit 45 included in the server C40 after the execution of the processing performed when the user using the terminal a60 sends the server A20 the request to write the file d.

The file d of the electronic file information 45a is updated in S24. Thus, after the processing related to the file-d write request 501d is completed, “/data/d” is updated to “/data/d_2” in the electronic file information 45b.

FIG. 30 is a diagram showing the holding server information stored in the holding server storage unit 100 after the execution of the processing performed when the user using the terminal a60 sends the server A20 the request to update the file d.

Since the file d_2 is newly stored in the file storage unit 25 and the file a in each of the file storage unit 35 and the file storage unit 45 is updated with the file d_2, the holding server information 100b is updated in S26. Thus, “/data/d” of the “file path” is updated to “/data/d_2” in the holding server information 100g.

The specific examples have been given as to the series of processes executed by the servers 20, 30, and 40 and the distributed file management apparatus 10. As described above, even when the server 20, 30, or 40 accessed from the terminal 60 (or 65) does not hold the file related to the request of the user, the user can obtain the desired file when the other server hold the file.

Moreover, when a write request is sent, all the servers holding the file related to this write request can be updated. Thus, the file synchronization can be achieved.

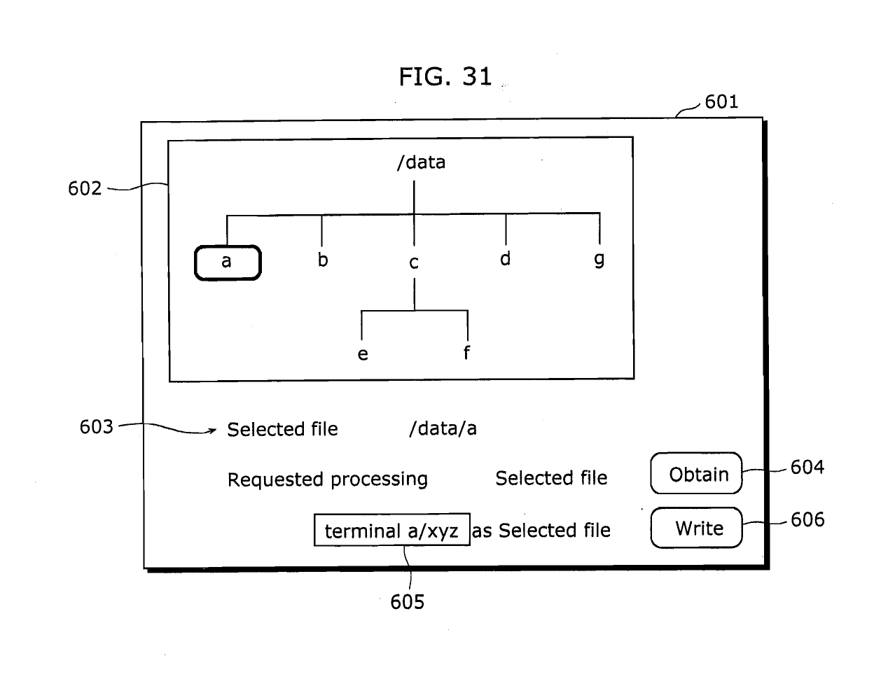

Next, an explanation is given as to examples of an input screen and a result display screen shown on a monitor connected to the terminal 60 (or 65) used by the user, with reference to FIGS. 31 to 33.

FIG. 31 is a diagram showing an example of a screen which is displayed on the monitor connected to the terminal 60 (or 65) used by the user and which is used by the user for inputting a request regarding a specific file. While viewing the screen display shown in this diagram, the user sends an obtainment request or a write request to the server.

An input screen 601 shown as an example in this diagram includes a file structure display unit 602, a selected-file display unit 603, an obtain button 604, a write file input unit 605, and a write button 606.

The file structure display unit 602 displays the paths of the electronic files stored in the servers 20, 30, and 40 which are the management objects of the distributed file management apparatus 10.

The details displayed on the file structure display unit 602 have the same structure as the paths of the electronic files shown in FIG. 2, and are obtained by accessing the holding server information 100b of the distributed file management apparatus 10 from the terminal 60 (or 65) via the servers 20, 30, and 40.

Here, a file specified by “/data/g” is not held in any of the servers 20, 30, and 40. This diagram shows a case where the distributed file management apparatus 10 holds, separately from the holding server information 100b, the paths of the electronic files commonly held by the servers which are the management objects, so that inconsistency is caused in the holding server information 100b showing the locations of the electronic files actually held by the servers 20, 30, and 40.

The user selects the electronic file related to the obtainment request or the write request from among the electronic files displayed on the file structure display unit 602, using an input device such as a mouse. The present diagram shows an example where a cursor is placed on the file a in the file structure display unit 602 of the present diagram and thus the file a is being selected.

The selected-file display unit 604 displays the electronic file currently being selected by the user. In the present diagram, the file a is being selected as mentioned above. Thus, as the “Selected file” of the selected-file display unit 604, the path “/data/a” is displayed.

The obtain button 605 is used for sending the obtainment request to the terminal 60 (or 65). When the user presses the obtainment button 605 in the input screen 601 as shown in the present diagram, the terminal 60 (or 65) sends the request to obtain the file a to one of the servers 20, 30, and 40.

The write file input unit 606 updates the files held by the servers 20, 30, and 40, and inputs an electronic file to be newly stored. The present diagram shows an example where a file xyz held by the terminal a60 (or 65) that is specified by the path “terminal a/xyz” is to be inputted.

The write button 606 is used for sending the write request to the terminal 60 (or 65). When the user presses the write button 606 in the input screen 601 as shown in the present diagram, the terminal 60 (or 65) sends the request to update the file a to one of the servers 20, 30, and 40 since the file a is being selected. The entity after the update is the file xyz inputted to the write file input unit 606.

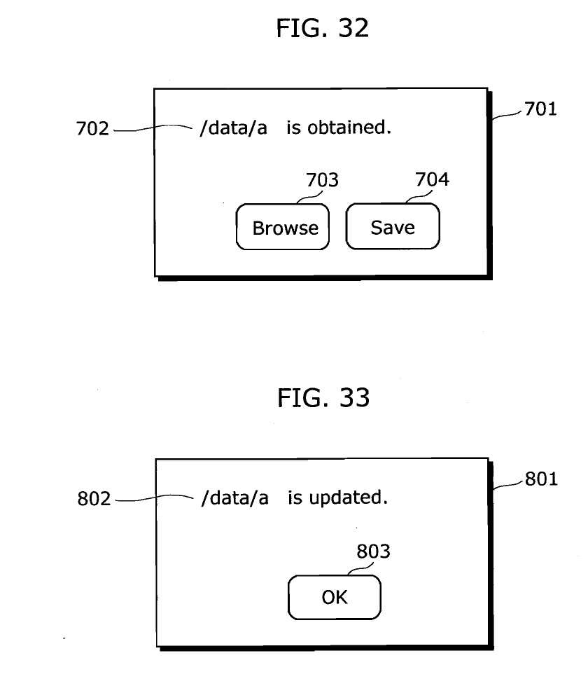

FIG. 32 is a diagram showing an example of a result displayed on the monitor connected to the terminal 60 (or 65) used by the user, when the user specifies a request to obtain the file a.

An obtained-result display screen 701 shown in the present diagram is a screen displayed on the monitor when the terminal 60 (or 65) used by the user obtains the file a by sending the request to obtain the file a.

The obtained-result display screen 701 includes an obtained-file display unit 702, a browse button 703, and a save button 704.

The obtained-file display unit 702 displays a name of the obtained file.

The browse button 703 is used for having the obtained file displayed on the monitor. When the user presses this button using the mouse or the like, the obtained file is displayed on the monitor.

The save button 704 is used for having the obtained file saved in the storage unit of the terminal 60 (or 65). When the user presses this button using the mouse or the like, the obtained file is saved in the storage unit of the terminal 60 (or 65).

FIG. 33 is a diagram showing an example of a result displayed on the monitor connected to the terminal 60 (or 65) used by the user, when the user specifies a request to update the file a.

An update result display screen 801 is a screen displayed on the monitor when the processing related to the request to update the file a is completed.

The update result display screen 801 includes an update result display unit 802 and a confirm button 703.

When a write request sent from the terminal 60 (or 65) is a request to update an electronic file, the update result display unit 802 displays a name of the electronic file related to the update request and also displays that the processing is completed.

Accordingly, the user using the terminal 60 (or 65) can see that the processing is completed.

The confirm button 703 closes the update result display screen 801 when pressed.

With the display screens like these, the user can send a request and obtain the result of the processing related to the request, on the monitor.

Up to this point, the explanation has been given as to the distributed file management apparatus and the distributed file management system according to the embodiment of the present invention. However, the present invention is not limited to this embodiment.

For example, according to the distributed file management system of the present embodiment, the write destination notification is sent immediately after the lock instruction is issued as shown in FIG. 10. However, after the lock instruction is sent and then the lock of the server which received the lock instruction is confirmed, the write destination notification may be sent.

### INDUSTRIAL APPLICABILITY

The present invention can be applied to an apparatus or a system which manages electronic files held by a plurality of servers in a distributed manner. In particular, the present invention can be applied to an apparatus which manages a plurality of file servers and each file server, and to an apparatus which manages a plurality of WWW (World Wide Web) servers and each WWW server.

1. A distributed file management system in which one of a plurality of servers, each being connected via a communication line to a terminal used by a user and each including a file storage unit storing an electronic file, receives a request of the user sent from said terminal regarding an electronic file, executes processing related to the request of the user, and sends a result of the executed processing to said terminal, said distributed file management system comprising
a distributed file management apparatus configured to send, in response to an inquiry from an access source server receiving the request of the user regarding the electronic file, information concerning a holding server including said file storage unit that stores the electronic file related to the request of the user, to said access source server.

2. The distributed file management system according to claim 1,
wherein said distributed file management apparatus includes:
a file location storing unit configured to store file location information in which server identification information for said each server is associated with information concerning the electronic file stored in said file storage unit included in said server;
a holding server determining unit configured to determine said holding server by reference to the file location information, in response to the inquiry from said access source server; and
a holding server sending unit configured to send, to said access source server, the information concerning said holding server determined by said holding server determining unit.

3. The distributed file management system according to claim 2 further comprising a plurality of servers,
wherein each of said plurality of servers includes:
a request receiving unit configured to receive the request inputted to said terminal by the user;
a holding server receiving unit configured to receive the information concerning said holding server that is sent from said holding server sending unit;
an access destination determining unit configured to determine an access destination related to the request of the user, on the basis of the information concerning said holding server that is received by said holding server receiving unit;
a processing requesting unit configured to request the access destination, which is determined by said access destination determining unit, to perform the processing related to the request of the user;
a result obtaining unit configured to obtain, from the access destination, a result of the processing which said processing requesting unit requests the access destination to perform; and
a result sending unit configured to send the result obtained by said result obtaining unit to said terminal.

4. The distributed file management system according to claim 3,
wherein said each server further includes a completion judging unit configured to judge that the processing related to the request of the user is completed when said result obtaining unit obtains the result of the processing related to the request of the user from each access destination determined by said access destination determining unit, and
said result sending unit is configured to send the result of the processing related to the request of the user to said terminal when said completion judging unit judges that the processing related to the request of the user is completed.

5. The distributed file management system according to claim 4,
wherein said each server further includes a completion notifying unit configured to, when said completion judging unit judges that the processing related to the request of the user is completed, notify said distributed file management apparatus of: information concerning the access destination where write processing is performed in relation to the request of the user; and information concerning the electronic file, and
said distributed file management apparatus further includes a location information updating unit configured to update the file location information with the information concerning the access destination and the information concerning the electronic file obtained from said completion notifying unit.

6. The distributed file management system according to claim 5,
wherein said distributed file management apparatus further includes a lock instruction sending unit configured to, when said holding server determining unit judges that the request of the user is to write an electronic file and that said holding server is present, send said holding server an instruction to lock said file storage unit included in said holding server.

7. The distributed file management system according to claim 6,
wherein said distributed file management apparatus further includes a lock release sending unit configured to, when receiving the notification from said completion notifying unit, send said holding server, to which said lock instruction sending unit sent the instruction, an instruction to unlock said file storage unit included in said holding server.

8. The distributed file management system according to claim 5,
wherein said access destination determining unit includes a first determining unit configured to, when: the request of the user is to obtain an electronic file; said file storage unit included in said access source server does not store the electronic file related to the request of the user; and the information concerning said holding server that is received by said holding server receiving unit includes the server identification information, determine that said server specified by the information concerning said holding server is the access destination relevant to processing of obtaining the electronic file related to the request of the user and to determine that said file storage unit included in said access source server is the access destination relevant to processing of writing the electronic file related to the request of the user.

9. The distributed file management system according to claim 5,
wherein said access destination determining unit includes a second determining unit configured to, when: the request of the user is to write an electronic file; and the information concerning said holding server that is received by said holding server receiving unit includes the server identification information, determine that said file storage unit included in said access source server and said server specified by the information concerning said holding server are the access destinations relevant to processing of writing the electronic file related to the request of the user.

10. The distributed file management system according to claim 5,
wherein said access destination determining unit includes a third determining unit configured to, when: the request of the user is to write an electronic file; and the information concerning said holding server that is received by said holding server receiving unit does not include the server identification information, determine that said file storage unit included in said access source server is the access destination relevant to processing of writing the electronic file related to the request of the user.

11. The distributed file management system according to claim 5,
wherein said access destination determining unit includes a fourth determining unit configured to, when: the request of the user is to obtain an electronic file; said file storage unit included in said access source server does not store the electronic file related to the request of the user; and the information concerning said holding server that is received by said holding server receiving unit does not include the server identification information, determine that the access destination related to the request of the user is not present.

12. The distributed file management system according to claim 8,
wherein said each server further includes a writing unit configured to write the electronic file to said electronic file storage unit and, after completion of the write processing, to notify said result obtaining unit that the write processing is completed,
said processing requesting unit is configured to, when said first determining unit determines the access destination, request said server specified by the information concerning said holding server to send the electronic file related to the request of the user, and to request said writing unit included in said access source server to write the electronic file related to the request of the user,
said result obtaining unit is configured to obtain, as a result of the processing related to the request of the user, the electronic file related to the request of the user from said server specified by the information concerning said holding server, and to obtain the notification, from said writing unit included in said access source server, that the processing of writing the electronic file is completed,
said completion judging unit is configured to, when said result obtaining unit obtains the electronic file related to the request of the user and the notification of the completion of the write processing, judge that the processing related to the request of the user is completed, and
said result sending unit is configured to, when said completion judging unit judges that the processing related to the request of the user is completed, send said terminal the electronic file related to the request of the user that is obtained by said result obtaining unit.

13. The distributed file management system according to claim 12,
wherein said completion notifying unit is configured to, when said completion judging unit judges that the processing related to the request of the user is completed, notify said distributed file management apparatus of the information concerning said access source server and the information concerning the electronic file obtained by said result obtaining unit, and
said location information updating unit is configured to update the file location information by storing, into said file location storage unit, the information concerning said access source server and the information concerning the electronic file obtained from said completion notifying unit, the pieces of information being stored in association with each other.

14. The distributed file management system according to claim 9,
wherein said each server further includes a writing unit configured to write the electronic file to said electronic file storage unit and, after completion of the write processing, to notify said result obtaining unit that the write processing is completed,
said processing requesting unit is configured to, when said second determining unit determines the access destination, request said server specified by the information concerning said holding server and said writing unit included in said access source server to write the electronic file related to the request of the user,
said result obtaining unit is configured to obtain, as a result of the processing related to the request of the user, the notification of the completion of the write processing from said server specified by the information concerning said holding server and said writing unit included in said access source server,
said completion judging unit is configured to, when said result obtaining unit obtains the notification of the completion of the write processing from said holding server and said writing unit included in said access source server, judge that the processing related to the request of the user is completed, and
said result sending unit is configured to, when said completion judging unit judges that the processing related to the request of the user is completed, send the notification of the completion of the write processing to said terminal.

15. The distributed file management system according to claim 14,
wherein said completion notifying unit is configured to, when said completion judging unit judges that the processing related to the request of the user is completed, notify said distributed file management apparatus of the information concerning the electronic file related to the request of the user, the information concerning said access source server, and the information concerning said holding server, and
said location information updating unit is configured to update the file location information by storing, into said file location storage unit, the information concerning the electronic file related to the request of the user, the information concerning said access source server, and the information concerning said holding server obtained from said completion notifying unit, the pieces of information being stored in association with each other.

16. The distributed file management system according to claim 10,
wherein said each server further includes a writing unit configured to write the electronic file to said electronic file storage unit and, after completion of the write processing, to notify said result obtaining unit that the write processing is completed,
said processing requesting unit is configured to, when said third determining unit determines the access destination, request said writing unit included in said access server to write the electronic file related to the request of the user,
said result obtaining unit is configured to obtain, as a result of the processing related to the request of the user, the notification of the completion of the write processing from said writing unit included in said access source server,
said completion judging unit is configured to, when said result obtaining unit obtains the notification of the completion of the write processing from said writing unit included in said access source server, judge that the processing related to the request of the user is completed, and
said result sending unit is configured to, when said completion judging unit judges that the processing related to the request of the user is completed, send the notification of the completion of the write processing to said terminal.

17. The distributed file management system according to claim 16,
wherein said completion notifying unit is configured to, when said completion judging unit judges that the processing related to the request of the user is completed, notify said distributed file management apparatus of the information concerning the electronic file related to the write request of the user and the information concerning said access source server, and
said location information updating unit is configured to update the file location information by storing, into said file location storage unit, the information concerning the electronic file related to the request of the user and the information concerning said access source server obtained from said completion notifying unit, the pieces of information being stored in association with each other.

18. A distributed file management method whereby one of a plurality of servers, each being connected via a communication line to a terminal used by a user and each including a file storage unit storing an electronic file, receives a request of the user sent from the terminal regarding an electronic file, executes processing related to the request of the user, and sends a result of the executed processing to the terminal, said distributed file management method comprising
sending, in response to an inquiry from an access source server receiving the request of the user regarding the electronic file, information concerning a holding server including the file storage unit that stores the electronic file related to the request of the user, to the access source server.

19. The distributed file management method according to claim 18, whereby one of a plurality of servers, each being connected via a communication line to a terminal used by a user and each including a file storage unit storing an electronic file, receives a request of the user sent from the terminal regarding an electronic file, executes processing related to the request of the user, and sends a result of the executed processing to the terminal, said distributed file management method comprising:
determining the holding server, in response to the inquiry from the access source server, by reference to file location information in which server identification information for the each server is associated with information concerning the electronic file stored in the file storage unit included in the server; and
sending information concerning the holding server determined in said determining.

20. A distributed file management program whereby one of a plurality of servers, each being connected via a communication line to a terminal used by a user and each including a file storage unit storing an electronic file, receives a request of the user sent from the terminal regarding an electronic file, executes processing related to the request of the user, and sends a result of the executed processing to the terminal, said distributed file management program causing a computer to execute
sending, in response to an inquiry from an access source server receiving the request of the user regarding the electronic file, information concerning a holding server including the file storage unit that stores the electronic file related to the request of the user, to the access source server.

21. The distributed file management program according to claim 20, whereby one of a plurality of servers, each being connected via a communication line to a terminal used by a user and each including a file storage unit storing an electronic file, receives a request of the user sent from the terminal regarding an electronic file, executes processing related to the request of the user, and sends a result of the executed processing to the terminal, said distributed file management program causing the computer to execute:
determining the holding server, in response to the inquiry from the access source server, by reference to file location information in which server identification information of the server is associated with information concerning the electronic file stored in the file storage unit included in the server; and
sending information concerning the holding server determined in said determining.
